(19) United States
(12) Patent Application Publication
(10) Pub. No.: US 2024/0394788 A1
(43) Pub. Date: Nov. 28, 2024

(54) METHODS AND SYSTEMS FOR USING AVATARS AND A SIMULATED CITYSCAPE TO PROVIDE VIRTUAL MARKETPLACE FUNCTIONS

(71) Applicant: TAG MultiMedia LLC, Clawson, MI (US)

(72) Inventor: Michelle ARMSTRONG, Royal Oak, MI (US)

(73) Assignee: TAG MultiMedia LLC, Clawson, MI (US)

(21) Appl. No.: 18/795,454

(22) Filed: Aug. 6, 2024

Related U.S. Application Data
(63) Continuation-in-part of application No. 17/839,069, filed on Jun. 13, 2022.
(60) Provisional application No. 63/210,157, filed on Jun. 14, 2021.

(51) Int. Cl. G06Q 30/0601; G06N 5/022

(52) U.S. Cl. CPC G06Q 30/0643; G06N 5/022

(57) ABSTRACT

A method is disclosed for sharing knowledge between avatars in a virtual marketplace platform, comprising: generating, via an artificial intelligence engine, one or more machine learning models trained to receive input from a customer virtual avatar, determine an output to respond to the input, wherein the input comprises a question and the output comprises an answer. The method includes receiving interaction data from a first virtual avatar. The interaction data includes the output within a first virtual marketplace environment and performance metrics associated with the output. The method includes generating, via the artificial intelligence engine, a knowledge base for the first virtual avatar using the interaction data. The knowledge base is operatively configured to store the interaction data corresponding to the performance metrics. The method includes transferring the knowledge base from the first virtual avatar to a second virtual avatar in a second virtual marketplace environment.

### CROSS-REFERENCE TO RELATED APPLICATIONS

The present application is a continuation-in-part application and claims the benefit of U.S. patent application Ser. No. 17/839,069, filed Jun. 13, 2022, titled “METHODS AND SYSTEMS FOR USING AVATARS AND A SIMULATED CITYSCAPE TO PROVIDE VIRTUAL MARKETPLACE FUNCTIONS,” which claims the benefit of U.S. Provisional Application No. 63/210,157, titled “METHODS AND SYSTEMS FOR USING AVATARS AND A SIMULATED CITYSCAPE TO PROVIDE VIRTUAL MARKETPLACE FUNCTIONS” filed Jun. 14, 2021, the content of which is incorporated herein by reference in its entirety for all purposes.

### TECHNICAL FIELD

This disclosure relates to a virtual marketplace. More specifically, this disclosure relates to a system and method for a using avatars and a simulated cityscape to provide virtual marketplace functions.

This disclosure further relates to methods and systems for enabling the transfer and sharing of accumulated knowledge and expertise between avatars within a virtual marketplace environment. More specifically, this disclosure relates to a system and method that allows avatars to build and share a collective knowledge base, enhancing their ability to interact with users in a targeted manner tailored to the specific needs of a brand.

### BACKGROUND

Entities, such as companies or businesses that sell goods and/or provide services, often have brick and mortar physical locations from which they operate. In some instances, the physical locations may be geographically located such that customer traffic is not heavy. In some instances, the entities may be small, homegrown entities that experience difficulty competing with larger entities that provide similar goods and/or services as the smaller entity. For example, the smaller entities may lack the resources to grow a strong online presence and/or the means to grow their customer base.

The shift toward online commerce has intensified these challenges. Businesses, particularly small and medium-sized enterprises, encounter significant hurdles in attracting and retaining customers in the digital marketplace. Traditional advertising methods can be prohibitively expensive, limiting the ability of smaller businesses to reach a broader audience. Moreover, the digital environment often lacks the personalized interaction that customers expect when shopping in person, where knowledgeable staff can provide tailored assistance and recommendations.

As consumer expectations continue to evolve, there is a growing demand for more interactive and personalized shopping experiences in virtual spaces. Customers seek the convenience of online shopping without sacrificing the engagement and expertise associated with in-store visits. However, creating such an experience in a digital environment presents a complex challenge, requiring innovative solutions to bridge the gap between the physical and virtual worlds

Accordingly, there is a need for a system and method that allow for the dynamic accumulation and sharing of knowledge to facilitate retail experiences, such as in virtual marketplaces. Moreover, there is a need to provide enhanced customer service and engagement, effectively bridging the gap between digital and physical retail experiences, and offering an adaptable, scalable solution to the challenges faced by modern enterprises in the digital age.

### SUMMARY

Representative embodiments set forth herein disclose various techniques for enabling a virtual marketplace platform.

The present disclosure, in some embodiments, provides a solution to the problems and challenges outlined above by enabling avatars within a virtual marketplace to accumulate and share knowledge, thereby enhancing their ability to serve customers. In some embodiments, the system and method disclosed herein leverage generative artificial intelligence to develop avatars that can respond intelligently to customer inquiries, providing a level of interaction and personalization comparable to that of a physical retail setting. By allowing the transfer and sharing of this accumulated expertise among avatars, businesses can optimize their customer engagement strategies utilizing artificial intelligence.

In one embodiment, a method for executing a virtual marketplace platform comprising: receiving one or more images of a physical location, wherein the one or more images comprise representations of one or more buildings associated with one or more entities present in the physical location; generating a virtual cityscape by modeling the one or more buildings associated with the one or more entities, wherein the virtual cityscape comprises a virtual map configured to be navigated by one or more virtual avatars, virtual vehicles, or both; generating the one or more virtual avatars and including the one or more virtual avatars in the virtual cityscape, wherein: at least one of the virtual avatars comprises an entity virtual avatar associated with an entity occupying a virtual building in the virtual cityscape, and the entity virtual avatar is included inside the virtual building associated with the entity, and at least one of the virtual avatars comprises a customer virtual avatar associated with a customer, and the customer virtual avatar is enabled to traverse the virtual cityscape by moving throughout one or more virtual streets, entering and exiting virtual buildings associated with entities, or some combination thereof; receiving one or more images of an interior configuration of a real building associated with the virtual building; and generating a virtual interior configuration that is similar to the interior configuration depicted in the one or more images and using the virtual interior configuration to populate an interior of the virtual building with one or more goods, products, furniture, objects, decorations, flooring, walls, ceilings, doors, windows, or some combination thereof.

In another embodiment, a method for sharing knowledge between avatars in a virtual marketplace platform is disclosed herein. The method for sharing knowledge between avatars in a virtual marketplace platform, comprising: generating, via an artificial intelligence engine, one or more machine learning models trained to receive input from a customer virtual avatar, determine an output to respond to the input, wherein the input comprises a question and the output comprises an answer; receiving interaction data from a first virtual avatar, the interaction data comprising the output within a first virtual marketplace environment and performance metrics associated with the output; generating, via the artificial intelligence engine, a knowledge base for the first virtual avatar using the interaction data, wherein the knowledge base is operatively configured to store the interaction data corresponding to the performance metrics; transferring the knowledge base from the first virtual avatar to a second virtual avatar, wherein the second virtual avatar operates in a second virtual marketplace environment; and updating the second virtual avatar with the knowledge base, enabling the second virtual avatar to provide one or more targeted responses to user inquiries based on the knowledge base.

Implementations of the present disclosure can include one or more of the following features:

The step of monitoring user interactions with the second virtual avatar.

The step of updating the knowledge base based on monitoring user interactions with the second virtual avatar, wherein the updating of the knowledge base results in an updated knowledge base.

The step of transferring the updated knowledge base back to the first virtual avatar.

In some embodiments, a tangible, non-transitory computer-readable medium stores instructions that, when executed, cause a processing device to perform any of the methods disclosed herein.

In some embodiments, a system includes a memory device storing instructions and a processing device communicatively coupled to the memory device. The processing device executes the instructions to perform any of the methods disclosed herein.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a high-level component diagram of an illustrative system architecture according to certain embodiments of this disclosure.

FIG. 2 illustrates an example computer system.

FIG. 3 illustrates example operations of a method for providing a virtual marketplace platform including virtual avatars and a virtual cityscape according to certain embodiments of this disclosure.

FIGS. 4-48 illustrate example user interfaces and aspects of a virtual marketplace platform according to certain embodiments of this disclosure.

FIG. 49 illustrates example operations of a method for sharing knowledge between avatars in a virtual marketplace platform according to certain embodiments of this disclosure.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The term “metaverse” may refer to a virtual reality environment in which users can interact with entities, companies, users, objects, goods, services, vehicles, buildings, landscape, or the like in real-time or near real-time. Real-time may refer to under 2 seconds and near real-time may refer to longer than 2 seconds but less than 60 seconds.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

A technical problem may include exposing an entity's goods and/or services sold or offered in a physical location, such as a brick and mortar store, to customers that are not physically located at the physical location. The goods may be any suitable type of good (e.g., clothes, toys, sporting goods, foods, beverages, vehicles, video games, records, artwork, etc.) and the services may be any suitable type of service (e.g., financial, medical, mental, physical, emotional, planning, etc.). Further, cities include blocks of intermingled streets including stores along the streets, and another technical problem includes allowing a person to explore and access the cities via a software application.

A technical solution to the technical problems may include providing a virtual marketplace platform in a metaverse that includes a virtual cityscape of realistic buildings and entities that occupy the buildings. The virtual cityscape may be generated based on the internet protocol (IP) address of a computing device (e.g., smartphone, desktop, laptop, tablet, etc.) being used by the user, such that the virtual cityscape includes entities (e.g., companies, restaurants, stores, houses, neighborhoods, etc.) local to the user. The Figures include numerous example user interfaces of the virtual marketplace platform. The virtual marketplace platform may receive images obtained from one or more cameras, where the images capture the actual building and the entity's signs and decorations associated with the building. The images may be processed and a virtual three-dimensional map of the cityscape may be generated. The images may stitched together to provide a cohesive simulation of a virtual cityscape that looks identical or nearly identical to a real cityscape. The virtual cityscape may include virtual streets that are arranged the same as the real streets and virtual buildings arranged on the virtual streets the same as real buildings arranged on real streets.

The virtual buildings may be occupied by virtual entities associated with real entities (e.g., company, business, neighborhood, etc.). Various business rules may govern the way in which customer virtual avatars may interact within the virtual building representing a virtual store of the entity. Further, the business rules may govern how entity virtual avatars interact with the customer virtual avatars and/or act within the virtual store.

The owners or representatives of the entities that occupy the buildings may register or subscribe to be a part of the virtual marketplace platform. One or more virtual avatars of the owner and/or the representatives and/or employees may be generated based on an image of the owners, representatives, employees, characters, superheroes, animals, graphics, or the like. Thus, the virtual avatars may share the likeness with the real person associated with the virtual avatar. The virtual avatars may be disposed within a virtual building associated with the entity the owner, representative, and/or employee works for.

Further, the voice of the real person may be recorded and the virtual avatar may speak similarly as the real person. In some embodiments, an artificial intelligence engine may generate one or more machine learning models trained to answer questions asked by a customer using the virtual marketplace platform. The machine learning models may be trained to use natural language processing and training data to determine how to respond to a question or statement made by a customer. The machine learning models may continuously learn over time based on feedback provided by the customer whether the answer was satisfactory or not. Further, the machine learning models may learn over time based on the action performed by the customer over time. For example, if the customer asked for a certain product and the virtual avatar presents a product but the customer does not add the product to a virtual shopping cart, the machine learning model may be updated to provide a different product in a subsequent question.

The virtual avatar associated with the entity occupying the virtual building may be referred to as an “entity virtual avatar” herein. In some embodiments, if a user desires to view a website associated with the entity, the user may select a link and a popup window may be generated that includes the desired website. In some embodiments, the entity virtual avatar may be overlaid on a portion of the website and the user may interact with the virtual avatar in the website to help navigate the website. For example, the user may ask (e.g., via voice or text) the virtual avatar to show the user toys for kids and the virtual avatar may use a trained machine learning model to process the question and determine a location in the website where toys for kids are sold. The trained machine learning model may cause the website to transition to a Uniform Resource Locator (URL) associated with the location. The virtual avatar may respond with a statement “Here are toys for kids.”

In some embodiments, the entity virtual avatar may represent an agent of the entity occupying the virtual building. The entity virtual avatar may be positioned at an initial positon, such as behind a graphical representation of a desk near a front door of the virtual building. The entity virtual avatar may be programmed to greet a customer when the customer enters the virtual building.

Each customer that desires to access the virtual marketplace platform may create a user profile. The user profile may include their personal information (e.g., name, address, phone number, email, etc.), personal preferences (e.g., clothes, music, video games, any suitable product and/or service, etc.), and the like. A virtual avatar may be generated for each customer. The virtual avatar may be defaulted if the user does not provide a personal image. In some embodiments, the users may be able to use a tool to design their own virtual avatar. In some embodiments, the virtual marketplace platform may be communicatively coupled to an application programming interface of a third party service, and the virtual marketplace platform may obtain a “skin” or another virtual avatar used by the user via the third party service. For example, the user may perform a certain superhero character “skin” in a video game, and that skin may be imported into the virtual marketplace platform and associated with the virtual avatar of the user. The virtual avatar associated with a customer may be referred to as a “customer virtual avatar” herein.

As a customer virtual avatar navigates around a virtual building, numerous products may be presented on a user interface of a computing device of the customer. The products may be arranged on shelves identically or almost identically as they are in the real store associated with the entity. For example, the entity may be CVS® and there may be products, such as medicine, food, and beverages, etc. arranged in a particular way in the brick and mortar store associated with the CVS. The CVS may be virtually designed and generated based on an IP address of the user, such that the CVS virtually appears as though it is local to the user and the user recognizes its design.

Virtual representations of the products may be generated and arranged in the identical or nearly identical manner in the particular way in the virtual store representing the CVS in the virtual marketplace platform. In some embodiments, a user may select a particular product from a shelf by using an input peripheral (e.g., mouse, touchscreen, microphone, keyboard) and an enlarged graphical representation of the product may be presented on a user interface. In some embodiments, the user interface may more clearly focus on the enlarged graphical representation and may make the background have a blurred effect. The user may examine the enlarged graphical representation of the selected product by spinning it in any direction (e.g., 360 rotation), and information related to the selected product may be presented on the user interface. For example, the information related to the selected product may include a price, a brand, nutritional facts, an age requirement, a warning, a recommendation, instructions, and the like. The user may select to add the selected product to a virtual shopping cart. If the user desires to check out, a user interface may be presented of the virtual shopping cart and the user may proceed to perform a transaction via a digital payment system, such as PayPal®, Venmo®, Apple Pay®, Google Pay®, etc. In some embodiments, the virtual marketplace platform may be communicatively coupled to a digital wallet associated with the customer who makes the purchase. Funds included in the digital wallet may be used to purchase the selected product.

In some embodiments, any or all interactions of the customer virtual avatar in the virtual marketplace platform may be stored in a database. The interactions may be transmitted to third-party customer relationship management (CRM) platform. The CRM platform may populate its database with the information pertaining to the interactions of the customer virtual avatars. The CRM platform may identify certain customers that are similar and recommend to the entity providing the virtual marketplace platform to contact additional users that are similar to those customers. The CRM platform may contact other users that are similar to those customers. In some embodiments, the virtual marketplace platform may use an application programming interface to interact with the CRM platform.

In some embodiments, the virtual marketplace platform may track the sales of each entity, company, and/or business. The virtual marketplace platform may modify the metaverse to include the entities, companies, and/or businesses that perform better over a course of a period of time or during a particular time period (e.g., holiday). The virtual marketplace platform may take a percentage of each sale that is made in the metaverse.

In some embodiments, the Internet of Things (IoT) may be implemented with the virtual marketplace platform. For example, if the user is logged into the virtual marketplace platform and they enter their virtual home, the thermostat, refrigerator, stove, garage door, sprinklers, etc. may be presented in the user interface and the user may select to modify one or more of their operating parameters. In some embodiments, the user may generate a “scene” of a combination of operating parameters of the devices associated with IoT. For example, the user may, via the virtual marketplace platform, program the sprinkler to turn on at a certain time, the thermostat to change temperatures at that certain time, and a speaker to play certain music at that certain time.

In some embodiments, there may be a rewards program for the customer virtual avatar. For example, an account associated with the customer virtual avatar may receive a certain amount of money, currency, points, stars, etc. based on the amount of time the customer virtual avatar has been active, logged in, a member of, etc. the virtual marketplace platform. In some embodiments, the rewards program may award money, currency, points, starts, etc. based on whether the customer virtual avatar has referred the virtual marketplace platform to anyone. In some embodiments, the rewards program may award money, currency, points, starts, etc. based on whether the customer virtual avatar has completed a scavenger hunt where they complete tasks, run errands, etc. in the virtual marketplace platform. In some embodiments, the rewards program may award money, currency, points, starts, etc. based on whether the customer virtual avatar has shared the virtual marketplace platform with other users. Sharing may refer to transmitting a link (URL) to the virtual marketplace platform to other users email accounts.

In some embodiments, the virtual marketplace platform may enable companies, entities, businesses, etc. to pay for advertising. The advertisements may include a virtual avatar holding an item (e.g., sign) that includes the identity of the company, entity, business, etc. and/or an offer to purchase an item (e.g., food, beverage) offered by that company, entity, business, etc. If the user selects the advertising item (e.g., using an input peripheral such as a mouse, keyboard, touchscreen, etc.), then a user interface or a popup related to the company, entity, business, etc. may be presented on a display of the user's computing device and the user may select to order an item or service from that company, entity, business, etc. In some embodiments, the virtual marketplace platform may be connected to multiple APIs associated with multiple companies, entities, and/or businesses to enable ordering items and/or services from them. The ordered items and/or services may be delivered and/or scheduled to the user's physical location. In some embodiments, the virtual marketplace platform may enable companies, entities, businesses, etc. to advertise via virtual billboards, signs on vehicles, signs on buildings, etc.

At any time, while a customer virtual avatar is navigating a virtual store, the user associated with the customer virtual avatar may select a graphical element on the user interface to request to speak to the entity virtual avatar.

Multiple virtual avatars representing users may be deployed in the virtual cityscape simultaneously. In some embodiments, the virtual avatars associated with the customers may interact with each other via text (chat box) and/or voice. In some embodiments, customers may interact with each other via the virtual marketplace platform after they request consent from each other. In such a way, a customer who wishes to shop alone may reject any requests to interact from other virtual avatars. On the other hand, if friends are shopping in the virtual marketplace platform, they may communicate with each other as they walk the virtual streets of the virtual cityscape and enter various virtual stores and look at virtual goods and/or services.

The users may use computing devices to access the virtual marketplace platform and may use an input peripheral (e.g., mouse, touchscreen, keyboard, etc.) to traverse the streets and freely navigate the virtual cityscape. There may be various “checkpoints” overlaid on portions of the virtual cityscape to enable the user to advance more quickly to a portion of the virtual cityscape.

In some embodiments, the virtual avatar and its interactions may be accessible via an application programming interface (API), such that third-party systems may use the virtual avatar. For example, Ebay®, Amazon®, Epic Games®, etc. may connect to an API hosted by the entity managing the virtual marketplace platform and execute code that enables a virtual avatar to be implemented on their system. Thus the virtual avatars are interoperable between disparate systems.

In some embodiments, avatars in the virtual marketplace platform may speak different languages. In some embodiments, a processing device may be programmed to translate between the languages, which enables users from anywhere in the world to access the virtual marketplace platform.

In some embodiments, any data pertaining to a virtual avatar, answers to questions received via the chat bot/box, etc. may be transferred to other virtual cityscapes, systems, applications, etc. to enable the virtual avatars to operate there. Such a feature may enable training a machine learning model that controls a virtual avatar to be transportable, in some cases. Further, the virtual avatar may be provided based on a subscription fee such that it is licensable for a company.

In some embodiments, the virtual marketplace platform may provide a backend solution to running a digital office. The virtual marketplace platform may be implemented in computer instructions stored in a memory device and executed by a processing device. The digital office may include a customer relationship management tool, an email tool, a text marketing tool, a lead generation portal for acquiring and harvesting, a social media tool that enables an entity to manage multiple social media platforms (e.g., Facebook®, Instagram®, Twitter®, etc.), an art management tool, and the like. For example, the virtual marketplace platform may include a tool that enables an entity (e.g., business owner) to create media pieces, posts, ads, art, etc. and to post them to numerous social media platforms simultaneously. Any of the media created by the entity may be stored in a library of assets, which may be a centralized or distributed data source that enables the entire virtual marketplace platform to access them at any time.

In some embodiments, one component of the virtual marketplace platform may include a digital community network which is a marketing component built into the virtual marketplace platform. Information may be collected, following privacy guidelines and upon receiving consent, about customers that access the virtual stores and may be used to market to client. This information may be transmitted to a CRM platform in some embodiments.

In some embodiments, the virtual marketplace platform may enable small to medium size companies to compete with larger companies by providing a similar experience as shopping in person via the use the virtual store and virtual cityscape. Further, if a user living in Texas accesses a virtual store in the virtual cityscape of a city in Michigan, the user may order a product local to that city and it may be shipped to the user in Texas. Thus, the virtual cityscape enables expanding the footprint for small to medium sized companies that may only have one physical location in the city.

In some embodiments, if an entity hasn't configured their virtual store, a website link may be programmed to launch when a user tries to enter the virtual store and a browser window may be generated including the website link.

The use of the entity virtual avatars enables collecting richer data pertaining to customers. Conventionally, companies just use metrics pertaining to duration and website pages that customers land on or select. In some embodiments of the present disclosure, customer virtual avatars are having live conversations with AI bot virtual avatars or a virtual avatar operated by a human employee. The conversations may be analyzed and data may be extracted to identify more granular analytics. The entity virtual avatar can function as a personal assistant, an associate, a digital maintenance person online, etc. The data obtained during interaction between the customer and entity virtual avatars may be used as data to target for a desired audience, and an entity may begin marketing correctly to people based on what they want and what they came to the entity for.

In some embodiments, the virtual marketplace platform may include a delivery logistics component to enable delivery of products based on certain incentives (e.g., a discount if they order before a certain time period within a certain geographic area).

If the customer virtual avatar enters a virtual restaurant, instead of having to look through a menu, the customer may just say “I want a large pepperoni pizza” to the entity virtual avatar and the large pepperoni pizza may be presented on a user interface to the user. The user can order the large pepperoni pizza directly from the virtual marketplace platform. The pizza may be delivered by the actual company associated with the virtual avatar to the physical real address of the customer virtual avatar.

It should be noted that any suitable number of cities may be modeled as virtual cityscapes and a user in any geographic location may visit any of the virtual cityscapes to visit virtual entities that are using the virtual marketplace platform. As a result, users may be able to explore virtual stores representing real stores of real cities from anywhere in the world. Accordingly, the disclosed embodiments provide a metaverse of interacting with shops, businesses, entities, etc. to order goods and/or services from the comfort of a user's home in a fraction of the time it would take to drive to each of the shops, businesses, entities, etc. For example, a user could run errands in 10 minutes in the metaverse by ordering dinner for their family from a restaurant, ordering groceries for the week from a grocery store, scheduling a plumber, etc.

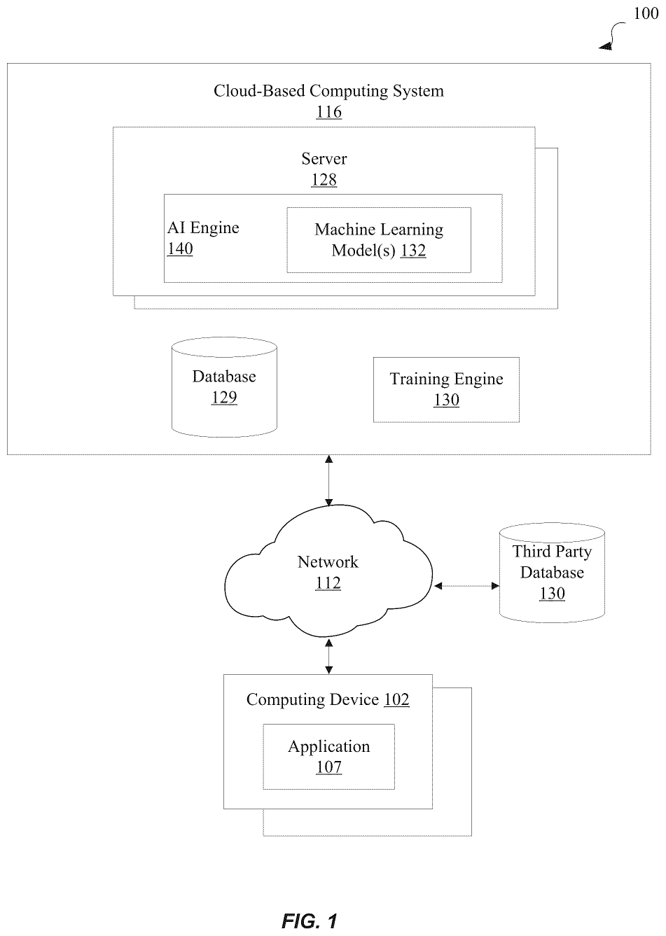

FIG. 1 illustrates a high-level component diagram of an illustrative system architecture 100 according to certain embodiments of this disclosure. In some embodiments, the system architecture 100 may include computing devices 102, a cloud-based computing system 116, and/or a third party database 130 that are communicatively coupled via a network 112. As used herein, a cloud-based computing system refers, without limitation, to any remote or distal computing system accessed over a network link. Each of the computing devices 102 may include one or more processing devices, memory devices, and network interface devices.

The network interface devices of the computing devices 102 may enable communication via a wireless protocol for transmitting data over short distances, such as Bluetooth, ZigBee, near field communication (NFC), etc. Additionally, the network interface devices may enable communicating data over long distances, and in one example, the computing devices 102 may communicate with the network 112. Network 112 may be a public network (e.g., connected to the Internet via wired (Ethernet) or wireless (WiFi)), a private network (e.g., a local area network (LAN), wide area network (WAN), virtual private network (VPN)), or a combination thereof.

The computing device 102 may be any suitable computing device, such as a laptop, tablet, smartphone, or computer. The computing device 102 may include a display that is capable of presenting a user interface of an application 107 (e.g., virtual marketplace platform). The computing device 102 may be operated by customer users and/or users associated with an entity (e.g., business, company, etc.). The application 107 may be implemented in computer instructions stored on a memory of the computing device 102 and executed by a processing device of the computing device 102. The application 107 may be served by as a website by the server 128. The application 107 may be a virtual marketplace platform and may be a stand-alone application that is installed on the computing device 102 or may be an application (e.g., website) that executes via a web browser. The application 107 may present a virtual cityscape, virtual avatars, virtual vehicles, virtual advertisements, virtual signs, virtual goods, virtual services, various screens, notifications, and/or messages to a user. The virtual goods and services may pertain to those specific real goods and services offered by entities that are associate with virtual building in the virtual cityscape. Numerous users (e.g., customers, entities, artificial intelligence bots, etc.) of the virtual marketplace platform may use the computing devices 102 that are communicatively coupled to each other via the network 112 and engaged in a virtual shared session.

In some embodiments, the cloud-based computing system 116 may include one or more servers 128 that form a distributed, grid, and/or peer-to-peer (P2P) computing architecture. Each of the servers 128 may include one or more processing devices, memory devices, data storage, and/or network interface devices. The servers 128 may execute an artificial intelligence (AI) engine 140 that uses one or more machine learning models 132 to perform at least one of the embodiments disclosed herein. The servers 128 may be in communication with one another via any suitable communication protocol. The servers 128 may enable configuring virtual stores, virtual avatars, virtual products, virtual services, and the like. The servers 128 may provide user interfaces that are role-specific to different computing devices of users having certain roles. For example, a merchant analytics dashboard may be presented to a user having a role associated with an entity (e.g., an agent of the entity). The entities may use a backend tool to provide business rules that govern how customer virtual avatars are enabled to interact with their virtual store. The servers 128 may enable customer virtual avatars to freely roam the virtual cityscape until certain boundaries are reached (e.g., the last street in a city).

In some embodiments, the cloud-based computing system 116 may include a database 129. The cloud-based computing system 116 may also be connected to a third party database 130. The databases 129 and/or 130 may store data pertaining to the entities, such as information about their products, information about their services, information about their entity (e.g., size, locations, revenue, profits), information about their marketing, information about their social media presence, etc. The database 129 or 130 may store a library of social media assets, information about the entities described above, information about customers (e.g., images, virtual avatar, personal information, preferences, etc.).

In some embodiments, the AI engine 140 may implement an expert system. The expert system may simulate the behavior and judgment of an entity. The expert system may obtain “knowledge” entered by the experts in the entity and the expert system may analyze situations, interpret the situation, and make actions in response to a certain stimuli (e.g., a user of the virtual marketplace platform asks the entity virtual avatar why the user should shop at the virtual store associated with the entity). The expert system may be configured to advise, provide demonstrations and instructions, derive solutions, diagnose, interpret inputs and provide relevant outputs, predict results, justify and conclude, and/or suggest alternative answers to a question. The expert system may use a knowledge base stored in the database 129. The expert system may include an inference engine. The knowledge base may include facts and rules. The rules may specify that if certain questions or actions are taken by the roles of the users, then certain responses will result. The specific rules may specify that various information and graphical elements are presented on a user interface for a specific role at a specific time if a specific question is asked. That is, the specific rules may specify that information is rendered in a specific format that is used and applied to create a desired result: a user interface specific for a customer.

The knowledge base contains knowledge in specific domains along with rules in order to solve problems, and form procedures that are relevant to the entity. The inference engine may acquire relevant data form the knowledge base, interpret it, and to find an answer to a question. The inference engine may use the following strategies to recommend solutions: forward chaining and backward chaining. Forward chaining may refer to the expert system answering the question “what can happen next?” The expert system may follow a chain of conditions and derivations to deduce the outcome after considering all of the facts and rules. The expert system may follow the strategy to determine a conclusion, result, or effect. Back chaining may refer to the expert system answering the question “why did this happen?” Depending upon what already occurred, the inference engine may identify the conditions that could have happened in the past to trigger the final result. This strategy may be used to find the cause or reason behind something happening.

The computing system 116 may include a training engine 130 capable of generating one or more machine learning models 132. Although depicted separately from the AI engine 140, the training engine 130 may, in some embodiments, be included in the AI engine 140 executing on the server 128. In some embodiments, the AI engine 140 may use the training engine 130 to generate the machine learning models 132 trained to perform inferencing operations, predicting operations, determining operations, controlling operations, or the like. The machine learning models 132 may be trained to answer questions asked by customer virtual avatars and/or users of the virtual marketplace platform. The machine learning models 132 may be trained with training data including a corpus of labeled questions and a corpus of labeled answers. In some embodiments, the machine learning models 132 may perform natural language processing and/or sentiment analysis and/or tone analysis. The answers selected and/or the response selected by the machine learning models 132 may be determined based on the question, sentiment, and/or tone. In some embodiments, the machine learning models 132 may be trained to generate statements to say to the customer virtual avatar based on the user's behavior, other users' behavior, the user's preferences, or the like. The one or more machine learning models 132 may be generated by the training engine 130 and may be implemented in computer instructions executable by one or more processing devices of the training engine 130 or the servers 128. To generate the one or more machine learning models 132, the training engine 130 may train the one or more machine learning models 132.

The training engine 130 may be a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 130 may be cloud-based, be a real-time software platform, include privacy software or protocols, or include security software or protocols.

To generate the one or more machine learning models 132, the training engine 130 may train the one or more machine learning models 132. The training engine 130 may use a base data set of questions as inputs and outputs pertaining to answers. In some embodiments, the base data set may refer to training data and the training data may include labels and rules that specify certain outputs occur when certain inputs are received.

In some embodiments, the one or more machine learning models 132 may be trained with training data including inputs pertaining to user preferences based on user order history and outputs labeled as suggested orders for the user.

The one or more machine learning models 132 may refer to model artifacts created by the training engine 130 using training data that includes training inputs and corresponding target outputs. The training engine 130 may find patterns in the training data wherein such patterns map the training input to the target output and generate the machine learning models 132 that capture these patterns. Although depicted separately from the server 128, in some embodiments, the training engine 130 may reside on server 128. Further, in some embodiments, the artificial intelligence engine 140, the database 150, or the training engine 130 may reside on the computing device 102.

As described in more detail below, the one or more machine learning models 132 may comprise, e.g., a single level of linear or non-linear operations (e.g., a support vector machine (SVM) or the machine learning models 132 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons, as well as to itself). For example, the machine learning model may include numerous layers or hidden layers that perform calculations (e.g., dot products) using various neurons. In some embodiments, one or more of the machine learning models 132 may be trained to use causal inference and counterfactuals.

For example, the machine learning model 132 trained to use causal inference may accept one or more inputs, such as (i) assumptions, (ii) queries, and (iii) data. The machine learning model 132 may be trained to output one or more outputs, such as (i) a decision as to whether a query may be answered, (ii) an objective function (also referred to as an estimand) that provides an answer to the query for any received data, and (iii) an estimated answer to the query and an estimated uncertainty of the answer, where the estimated answer is based on the data and the objective function, and the estimated uncertainty reflects the quality of data (i.e., a measure which takes into account the degree or salience of incorrect data or missing data). The assumptions may also be referred to as constraints and may be simplified into statements used in the machine learning model 132. The queries may refer to scientific questions for which the answers are desired.

The answers estimated using causal inference by the machine learning model may include optimized answers to certain question asked by users having certain characteristics that enable a higher likelihood the user may make a purchase. As the machine learning model estimates answers (e.g., scenario outcomes based on alternative action selection), certain causal diagrams may be generated, as well as logical statements, and patterns may be detected. For example, one pattern may indicate that “there is no path connecting object D and activity P,” which may translate to a statistical statement “D and P are independent.” If alternative calculations using counterfactuals contradict or do not support that statistical statement, then the machine learning model 132 may be updated. For example, another machine learning model 132 may be used to compute a degree of fitness which represents a degree to which the data is compatible with the assumptions used by the machine learning model that uses causal inference. There are certain techniques that may be employed by the other machine learning model 132 to reduce the uncertainty and increase the degree of compatibility. The techniques may include those for maximum likelihood, propensity scores, confidence indicators, or significance tests, among others.

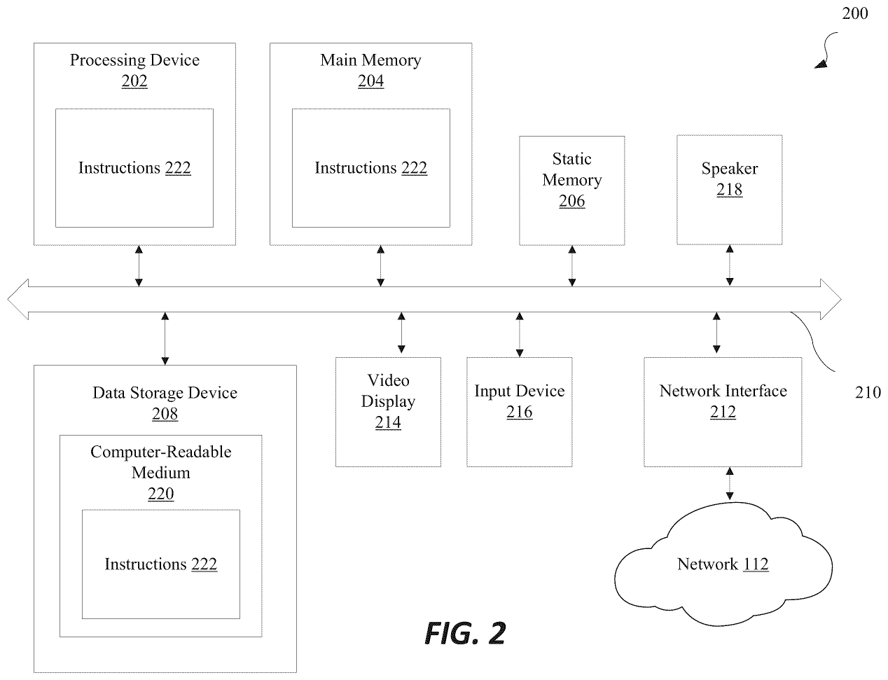

FIG. 2 illustrates an example computer system 200, which can perform any one or more of the methods described herein. In one example, computer system 200 may correspond to the computing device 102 or the one or more servers 128 of the cloud-based computing system 116 of FIG. 1. The computer system 200 may be capable of executing the application 107 (e.g. virtual marketplace platform) of FIG. 1. The computer system 200 may be connected (e.g., networked) to other computer systems in a LAN, an intranet, an extranet, or the Internet. The computer system 200 may operate in the capacity of a server in a client-server network environment. The computer system 200 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 200 includes a processing device 202, a main memory 204 (e.g., read-only memory (ROM), solid state drive (SSD), flash memory, dynamic random access memory (DRAM) such as synchronous DRAM (SDRAM)), a static memory 206 (e.g., solid state drive (SSD), flash memory, static random access memory (SRAM)), and a data storage device 208, which communicate with each other via a bus 210.

Processing device 202 represents one or more general-purpose processing devices such as a microprocessor, central processing unit, or the like. More particularly, the processing device 202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 is configured to execute instructions for performing any of the operations and steps discussed herein.

The computer system 200 may further include a network interface device 212. The computer system 200 also may include a video display 214 (e.g., a liquid crystal display (LCD) or a cathode ray tube (CRT)), one or more input devices 216 (e.g., a keyboard and/or a mouse), and one or more speakers 218 (e.g., a speaker). In one illustrative example, the video display 214 and the input device(s) 216 may be combined into a single component or device (e.g., an LCD touch screen).

The data storage device 216 may include a computer-readable medium 220 on which the instructions 222 (e.g., implementing the application 107, and/or any component depicted in the FIGURES and described herein) embodying any one or more of the methodologies or functions described herein are stored. The instructions 222 may also reside, completely or at least partially, within the main memory 204 and/or within the processing device 202 during execution thereof by the computer system 200. As such, the main memory 204 and the processing device 202 also constitute computer-readable media. The instructions 222 may further be transmitted or received over a network via the network interface device 212.

While the computer-readable storage medium 220 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

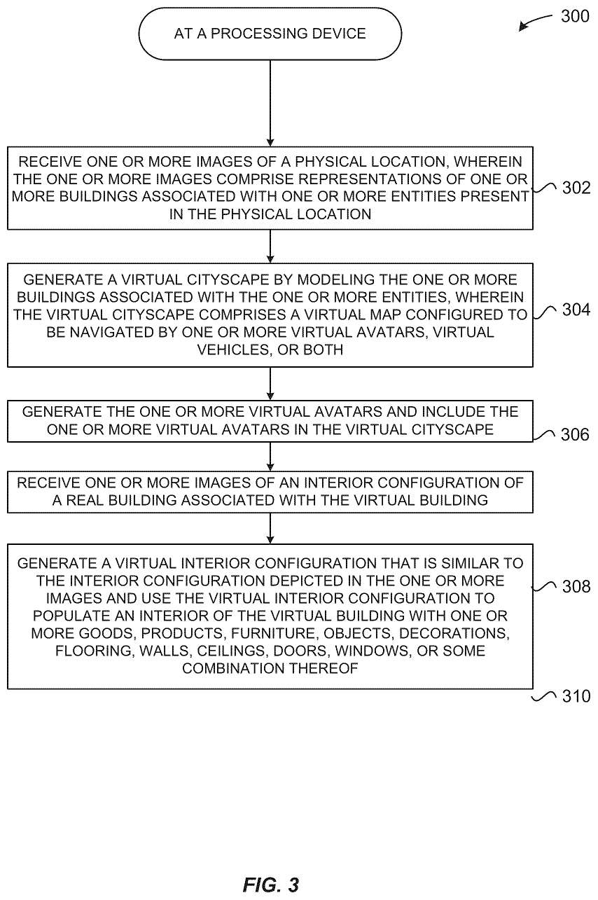

FIG. 3 illustrates example operations of a method 300 for providing a virtual marketplace platform including virtual avatars and a virtual cityscape according to certain embodiments of this disclosure. The method 300 may be performed by processing logic that may include hardware (circuitry, dedicated logic, etc.), software, or a combination of both. The method 300 and/or each of their individual functions, subroutines, or operations may be performed by one or more processors of a computing device (e.g., any component (server 128, etc.) of cloud-based computing system 116, or the computing device 102, of FIG. 1) implementing the method 300. The method 300 may be implemented as computer instructions stored on a memory device and executable by the one or more processors. In certain implementations, the method 300 may be performed by a single processing thread. Alternatively, the method 300 may be performed by two or more processing threads, each thread implementing one or more individual functions, routines, subroutines, or operations of the methods.

At block 302, the processing device may receive receiving one or more images of a physical location, wherein the one or more images comprise representations of one or more buildings associated with one or more entities present in the physical location.

At block 304, the processing device may generate a virtual cityscape by modeling the one or more buildings associated with the one or more entities, wherein the virtual cityscape comprises a virtual map configured to be navigated by one or more virtual avatars, virtual vehicles, or both.

At block 306, the processing device may generate the one or more virtual avatars and including the one or more virtual avatars in the virtual cityscape. At least one of the virtual avatars comprises an entity virtual avatar associated with an entity occupying a virtual building in the virtual cityscape, and the entity virtual avatar is included inside the virtual building associated with the entity. At least one of the virtual avatars comprises a customer virtual avatar associated with a customer, and the customer virtual avatar is enabled to traverse the virtual cityscape by moving throughout one or more virtual streets, entering and exiting virtual buildings associated with entities, or some combination thereof.

At block 308, the processing device may receive one or more images of an interior configuration of a real building associated with the virtual building.

At block 310, the processing device may generate a virtual interior configuration that is similar to the interior configuration depicted in the one or more images and using the virtual interior configuration to populate an interior of the virtual building with one or more goods, products, furniture, objects, decorations, flooring, walls, ceilings, doors, windows, or some combination thereof.

In some embodiments, the processing device may generate, via an artificial intelligence engine 140, one or more machine learning models 132 trained to receive input from a customer virtual avatar and determine an output to respond to the input, wherein the input comprises a question and the output comprises an answer. The question may be associated with a product or service offered by the entity and the answer may be associated with the product or the service.

In some embodiments, the processing device may enable two or more customer virtual avatars to communicate with each other after each of the users associated with the two or more customer virtual avatars provides consent.

In some embodiments, the processing device may present the answer on a user interface of a computing device of the customer, and receiving a selection to add the product or the service to a virtual shopping cart provided by the virtual marketplace platform.

In some embodiments, the processing device may provide a backend tool for the entity to enable the entity to create social media posts that are configured to be shared to a plurality of social media platforms simultaneously.

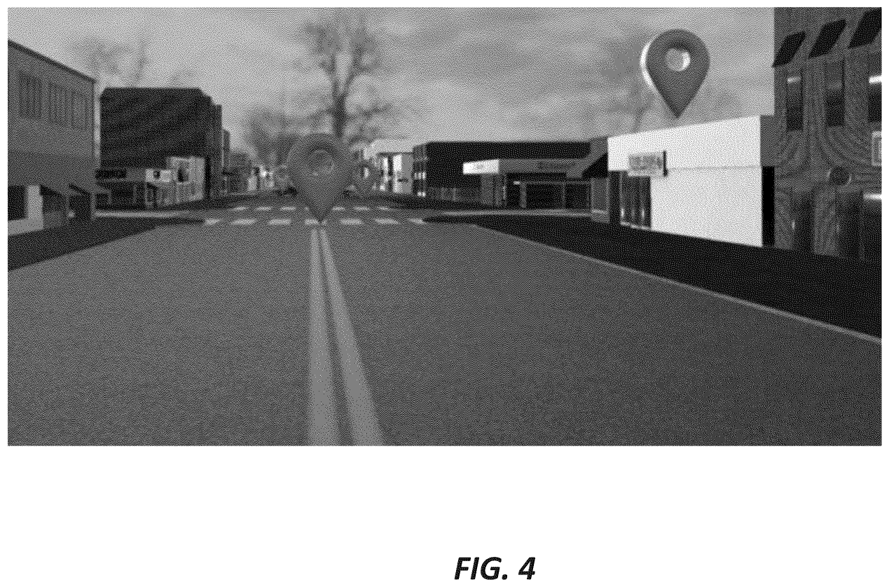

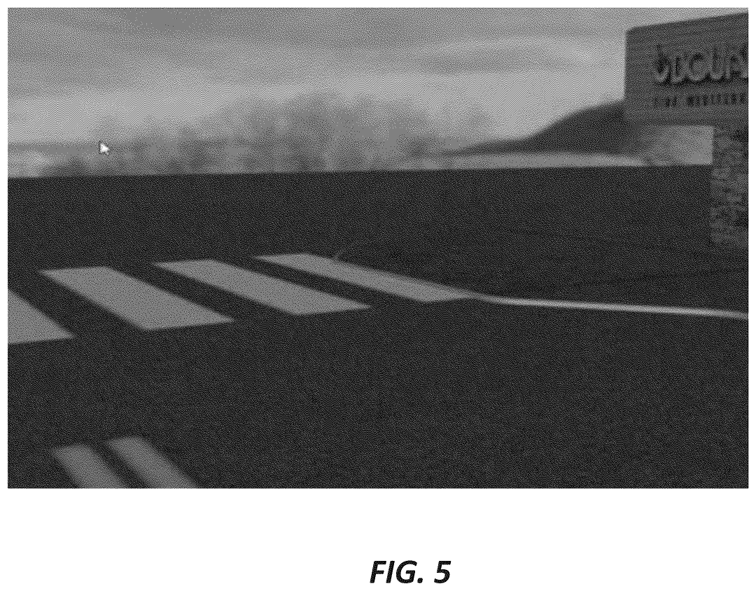

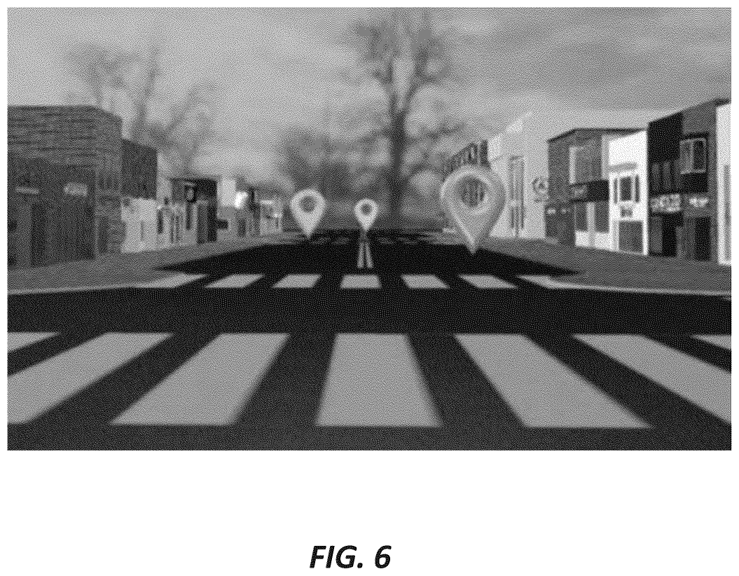

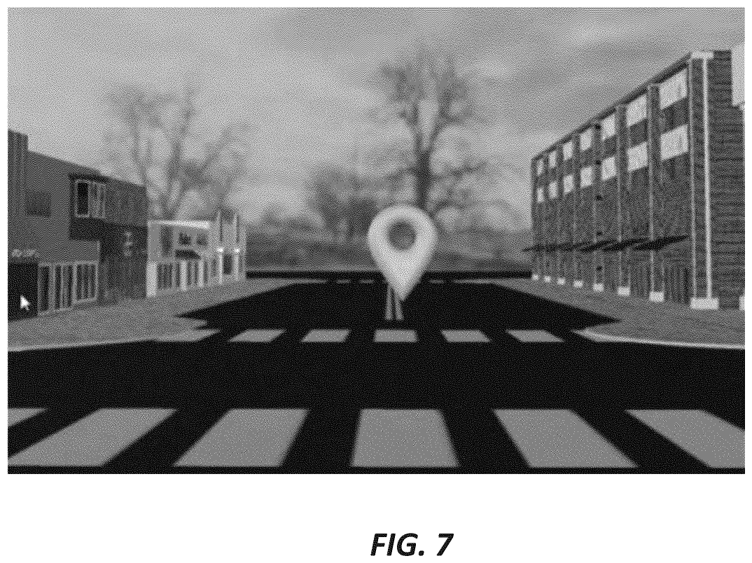

FIGS. 4-7 present a virtual cityscape including a virtual street and various virtual buildings occupied by entities along the virtual street. Various “checkpoints” are included in the user interface. The view presented is from the first-person perspective of a customer virtual avatar associated with a user. There may be other customer virtual avatars in the virtual cityscape. The checkpoints may be selected (e.g., using an input peripheral such as a mouse, keyboard, touchscreen, microphone, etc.) and the customer virtual avatar that selected the checkpoint may be advanced to a virtual location in the virtual cityscape associated with the checkpoint. The user may use an input peripheral to navigate in any direction in the virtual cityscape.

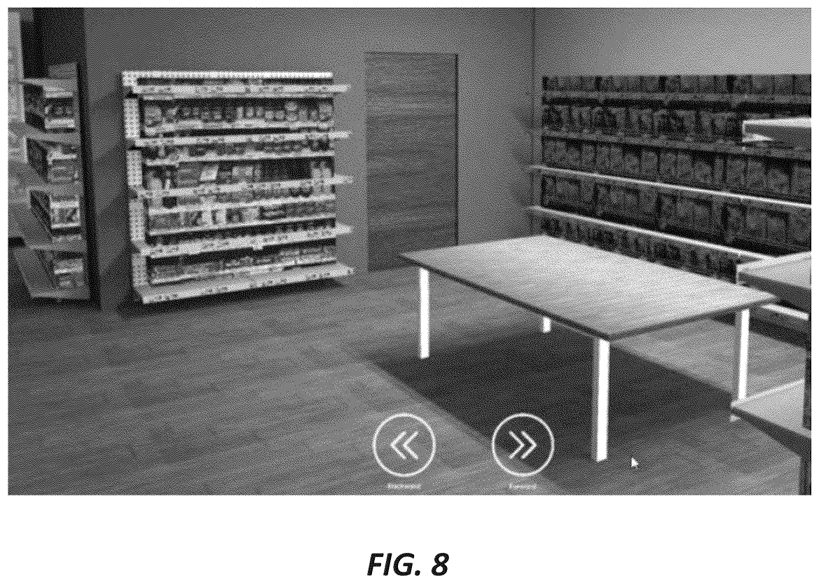

FIG. 8 presents an interior of a virtual store associated with an entity. This user interface may be presented on a computing device of a user associated with a customer virtual avatar when the customer virtual avatar enters a virtual building associated with the entity. As depicted, the products on the shelves may be arranged similarly to real products arranged in a real store associated with the entity. Images of the real store may be used to generate the virtual interior configuration of the entity's virtual store.

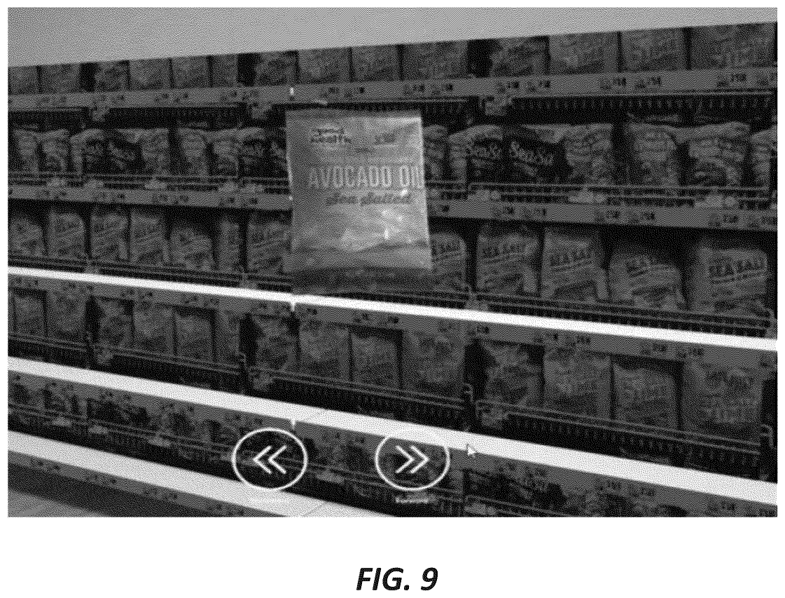

FIG. 9 presents a user interface the virtual marketplace platform where the user has selected a product on a shelf. As depicted, the product is presented as an enlarged graphical representation in focus, while a background of the shelf and other products are blurred. Graphical icons may be used to scroll between products on the shelf. The user may receive information pertaining to the selected product and may select to add the product to a virtual shopping cart for purchase.

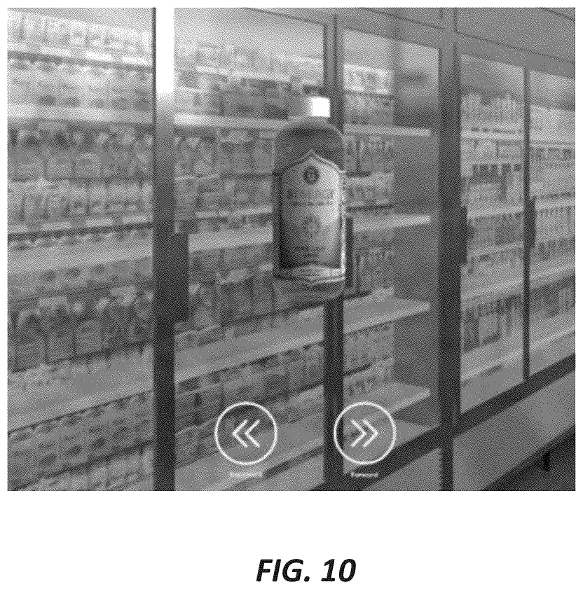

FIG. 10 presents another user interface for another product selected out of a refrigerator.

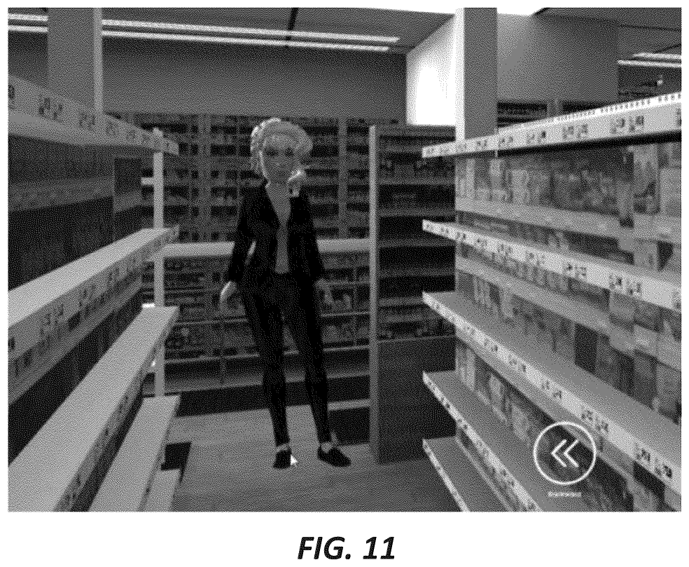

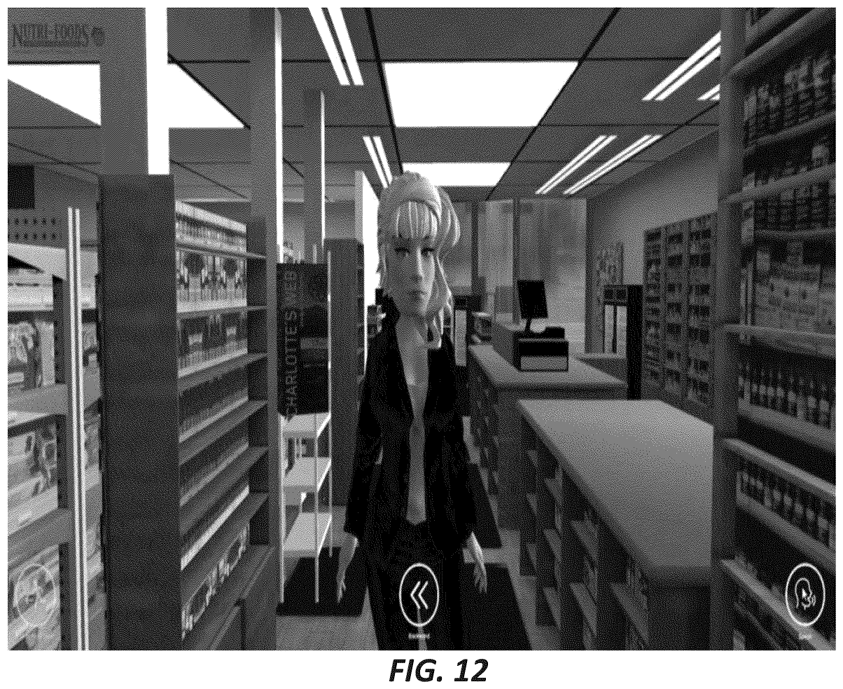

FIG. 11 presents a user interface including an entity virtual avatar of a representative of the entity occupying the virtual building in which the customer virtual avatar is shopping. The customer virtual avatar may interact with the entity virtual avatar and may ask any question in natural language. The entity virtual avatar may be controlled by one or more machine learning models 132 trained to answer questions and/or provide recommendations. The entity virtual avatar may guide the customer virtual avatar to a portion of the virtual store where a desired product is located, as depicted in FIG. 12.

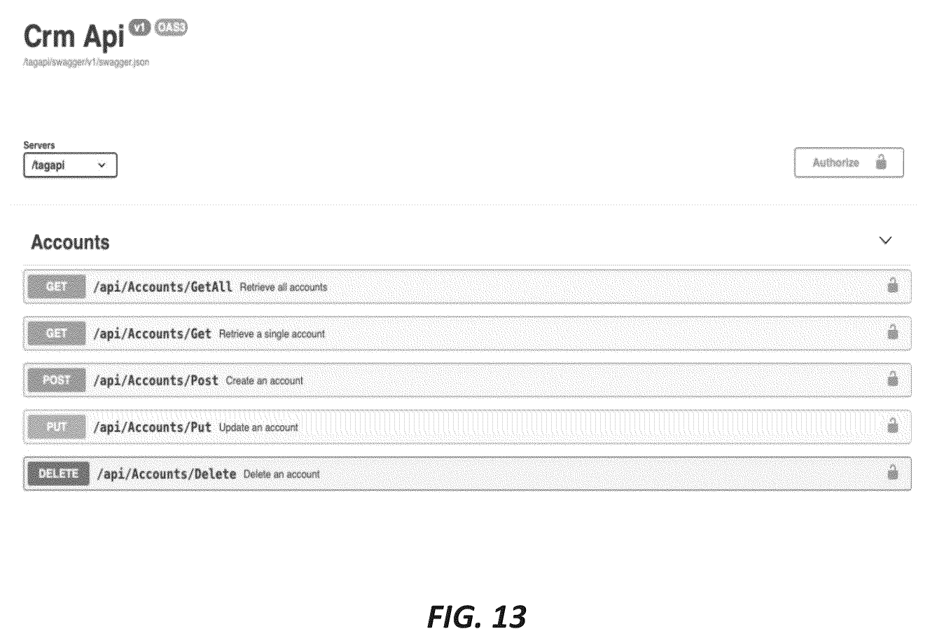

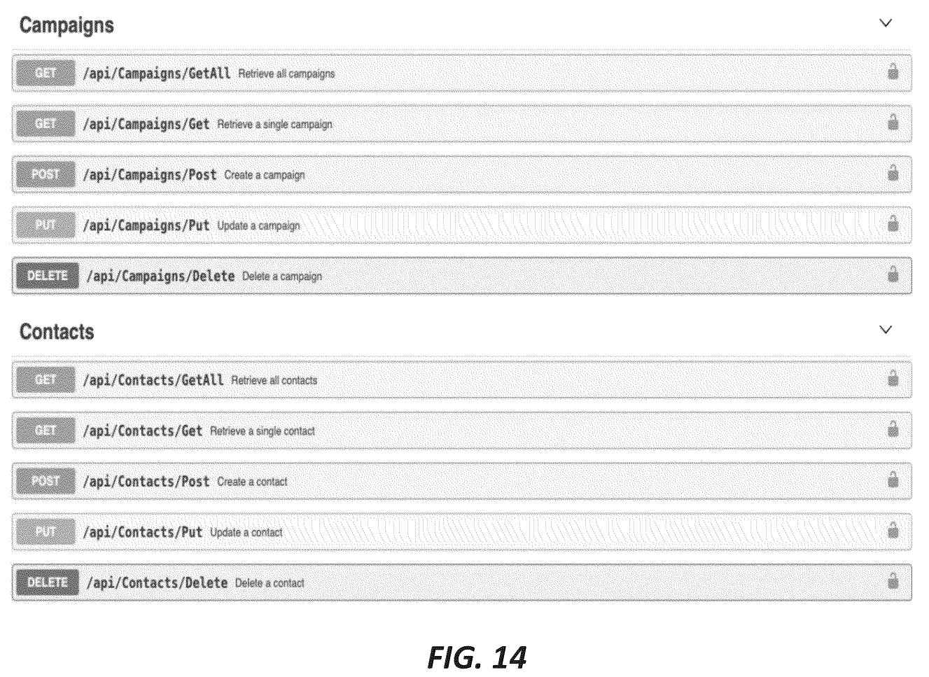

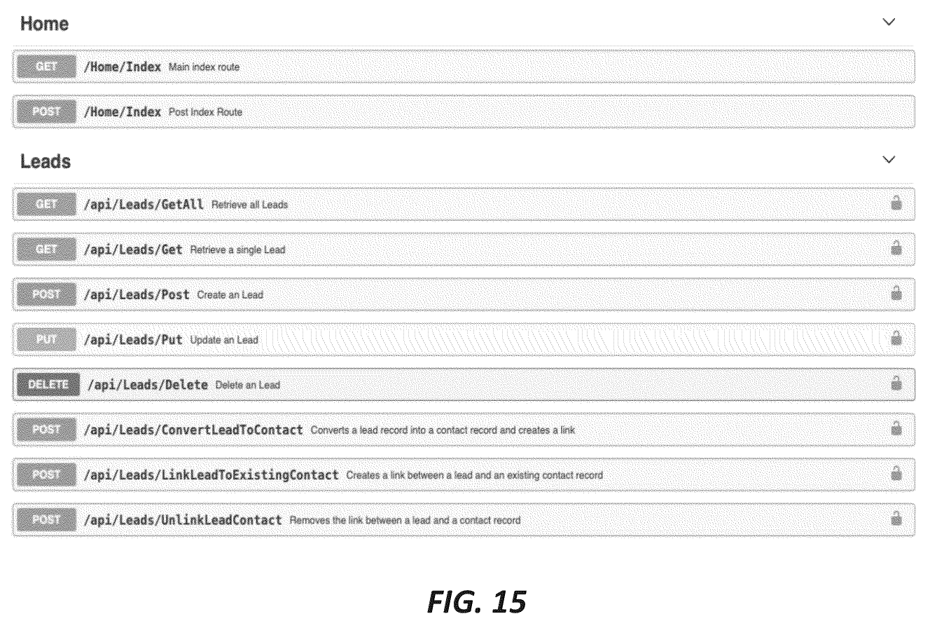

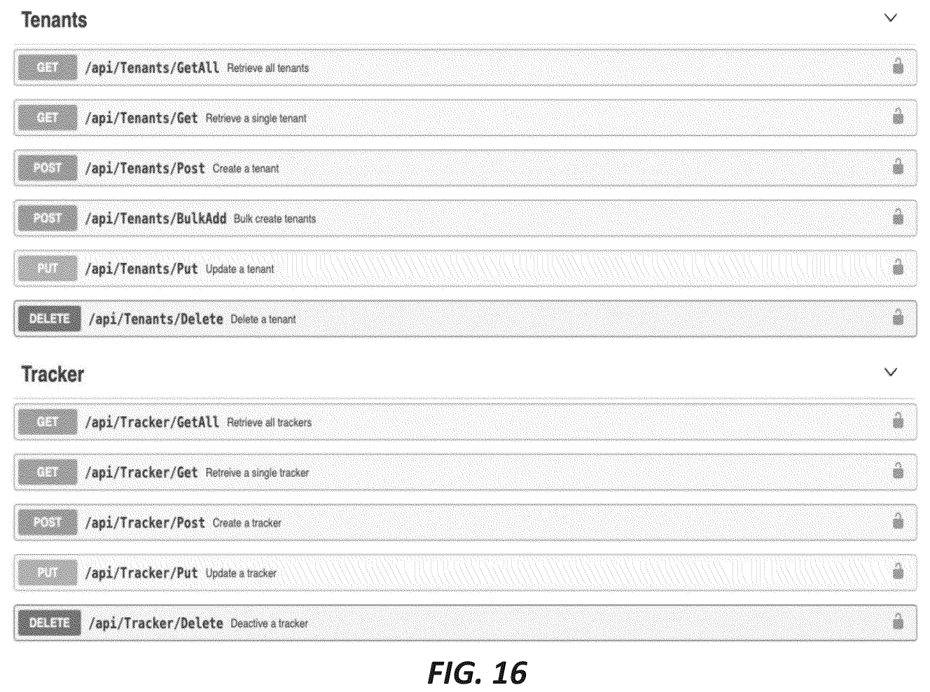

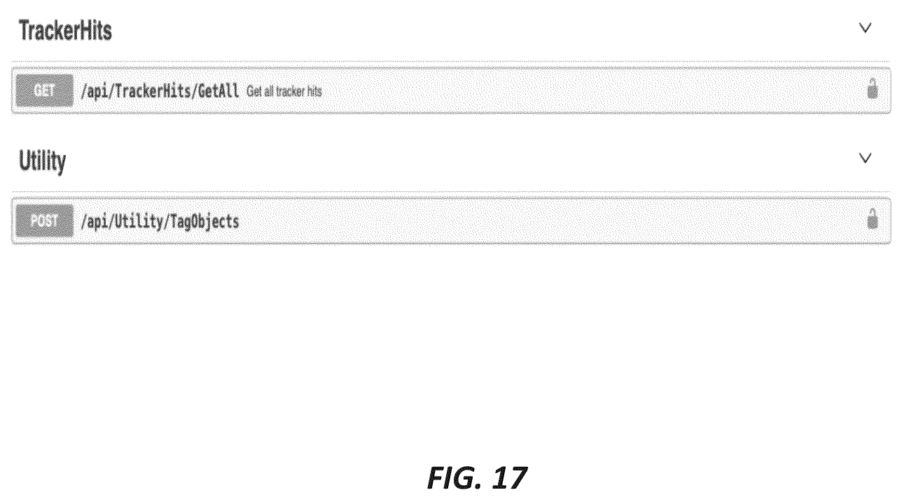

FIGS. 13-17 present various application programming interfaces (APIs) used by the virtual marketplace platform, in some embodiments.

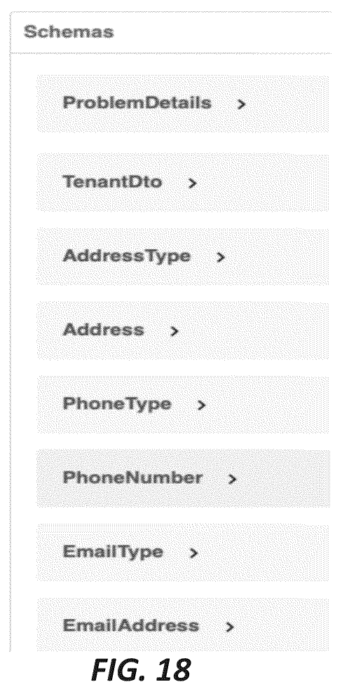

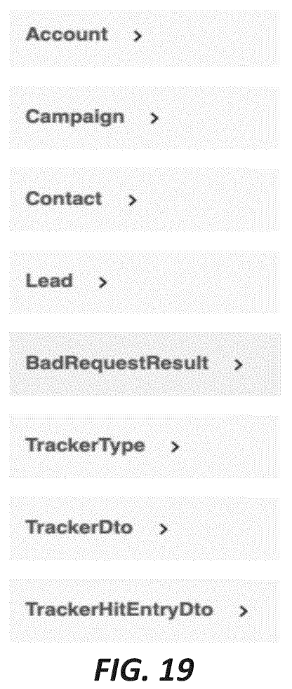

FIGS. 18-19 present various schemas used by the virtual marketplace platform, in some embodiments.

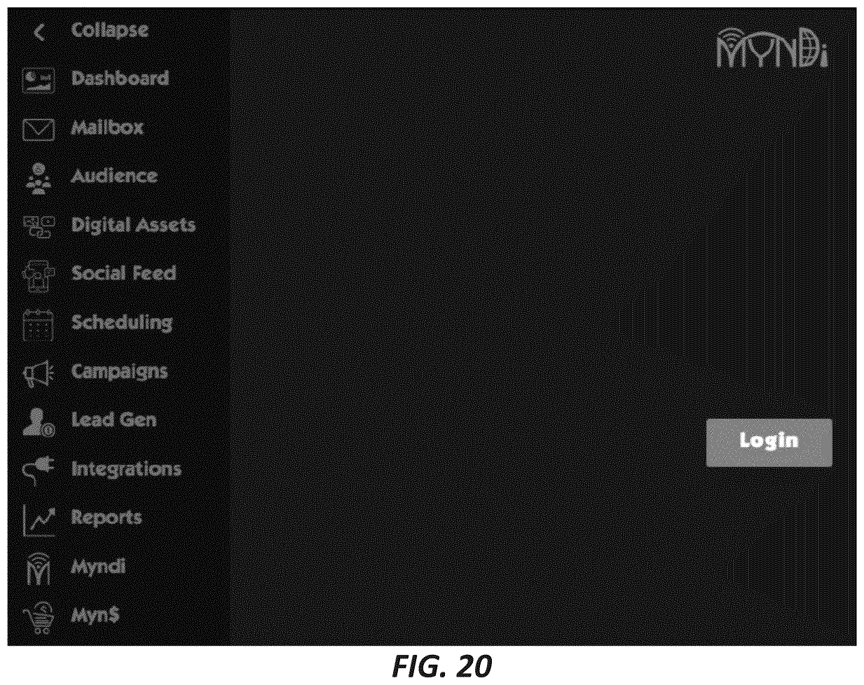

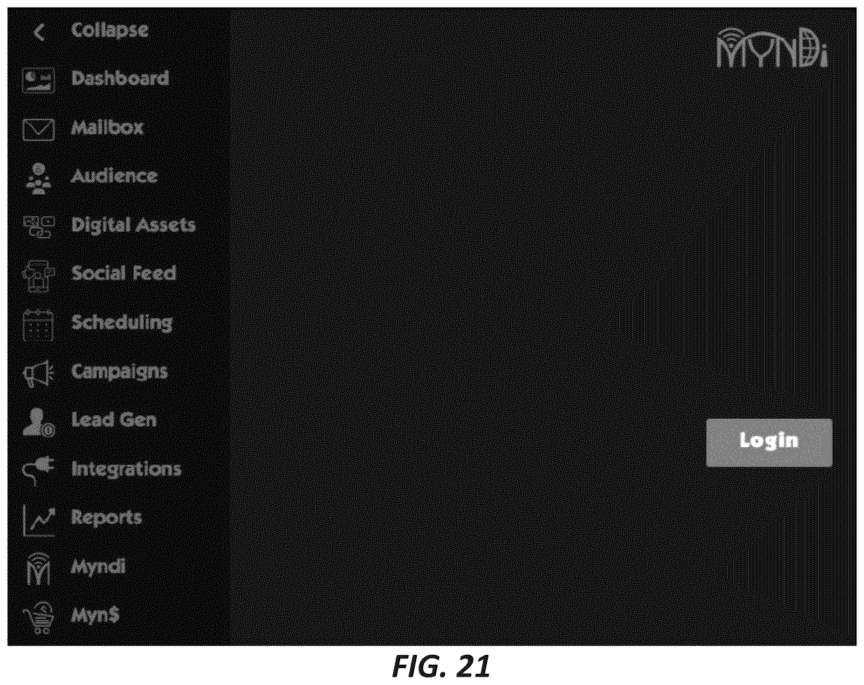

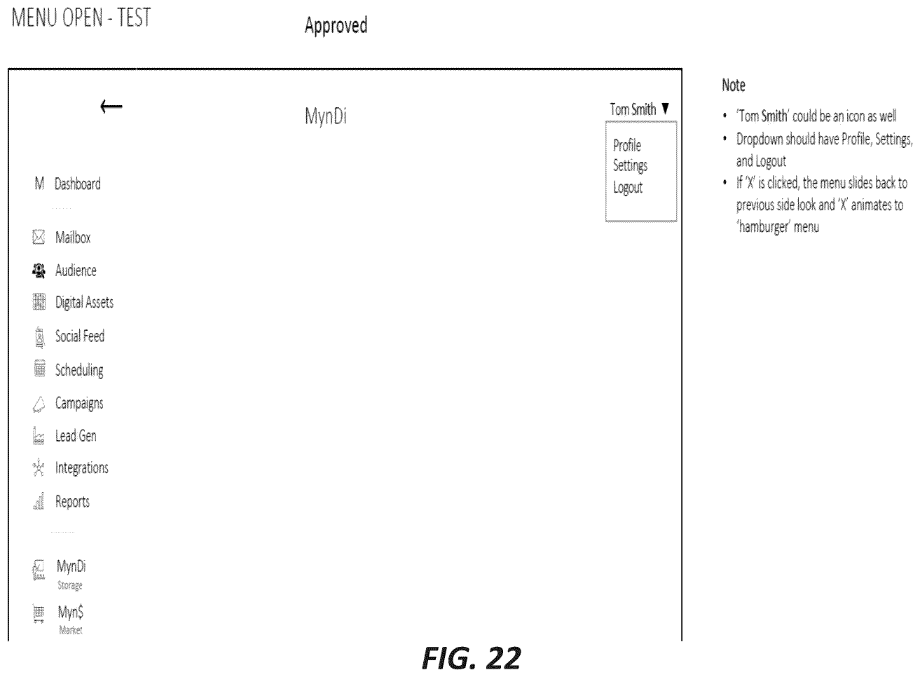

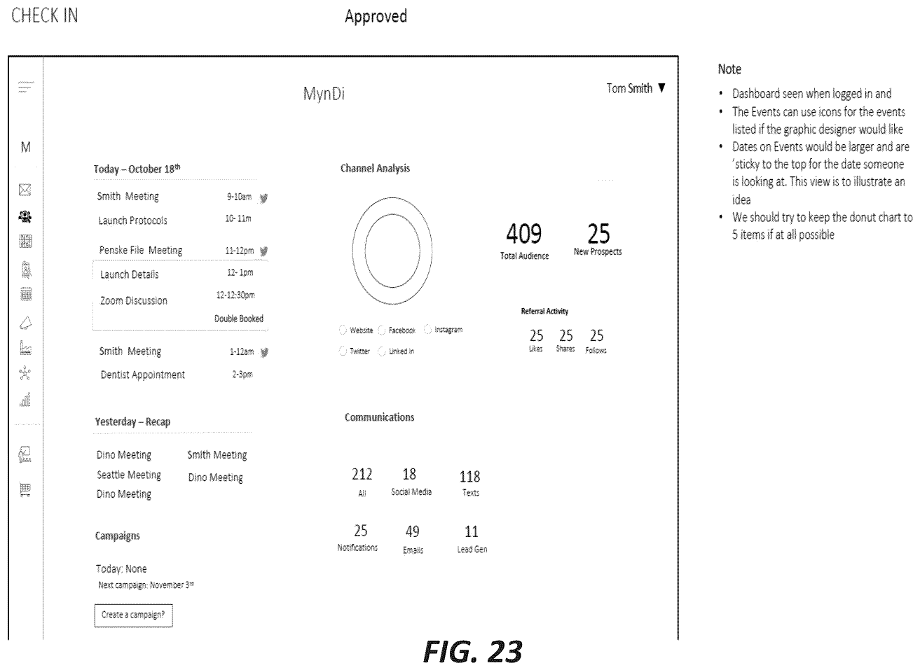

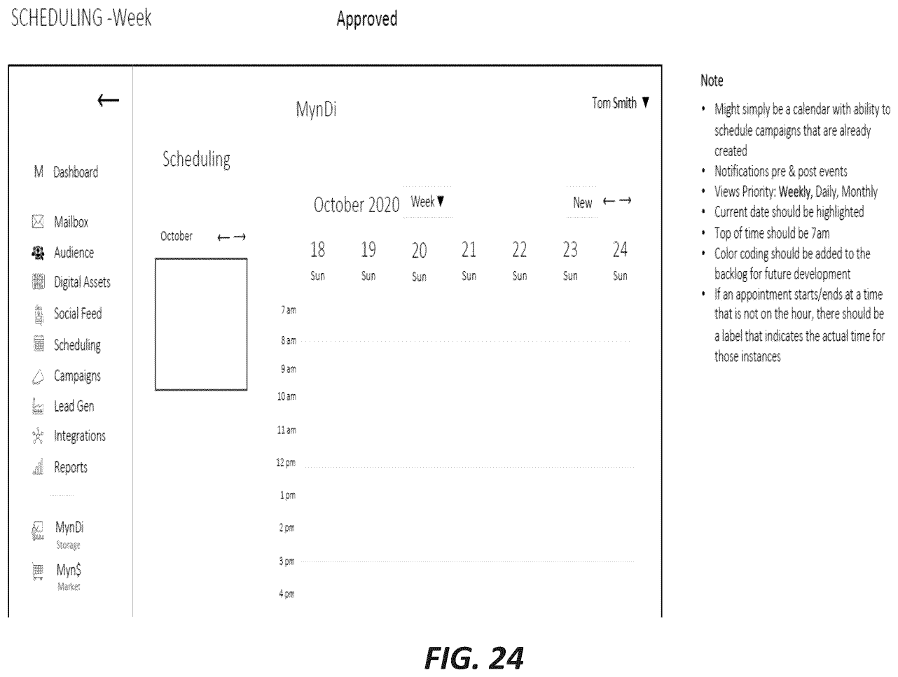

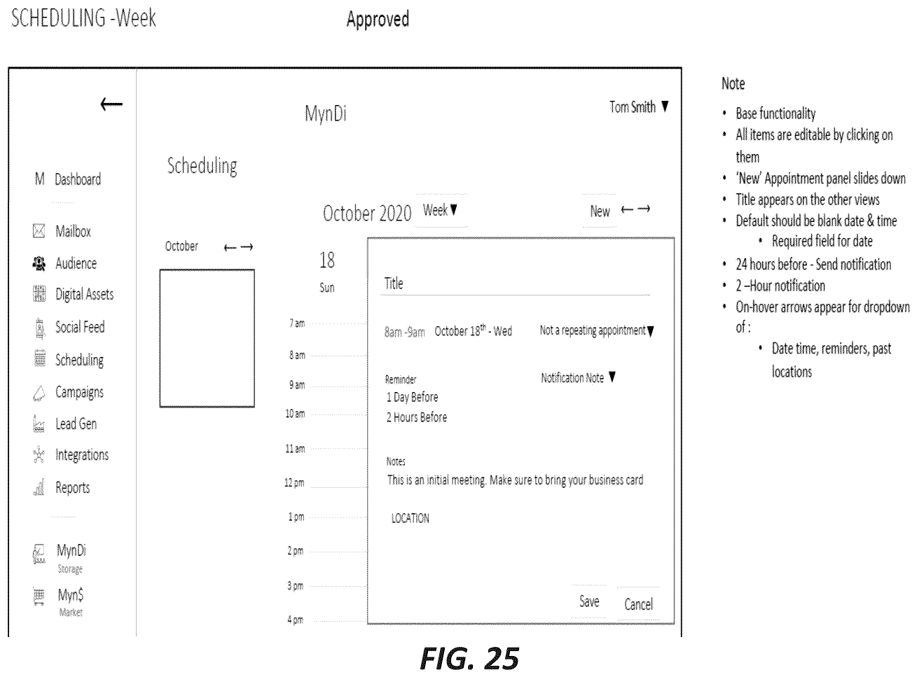

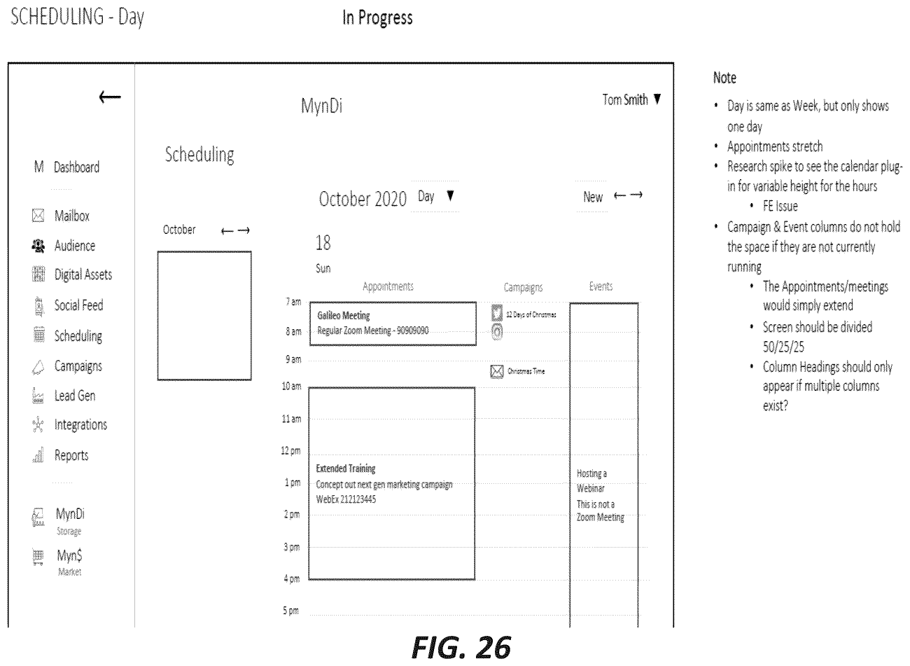

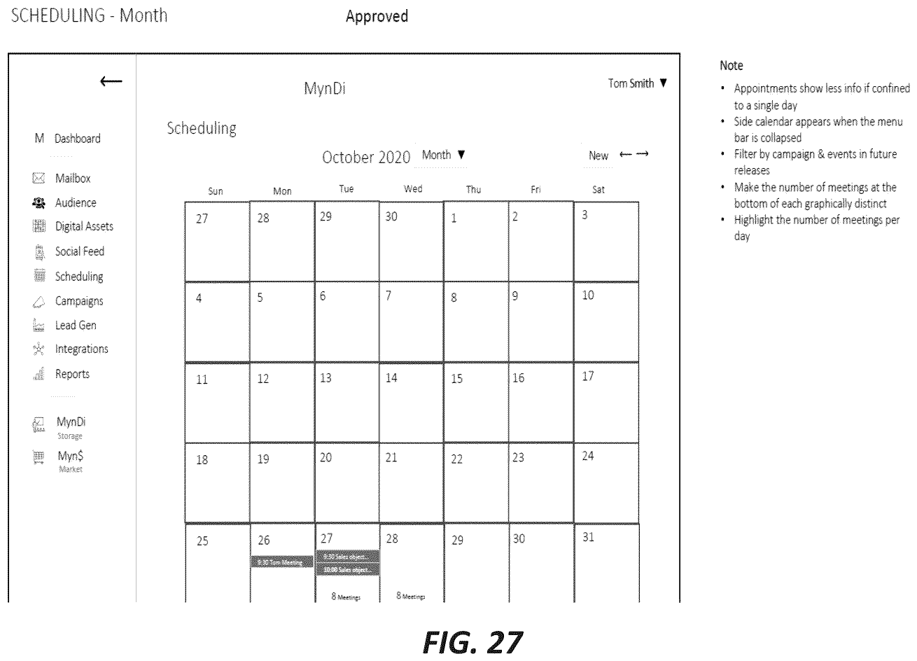

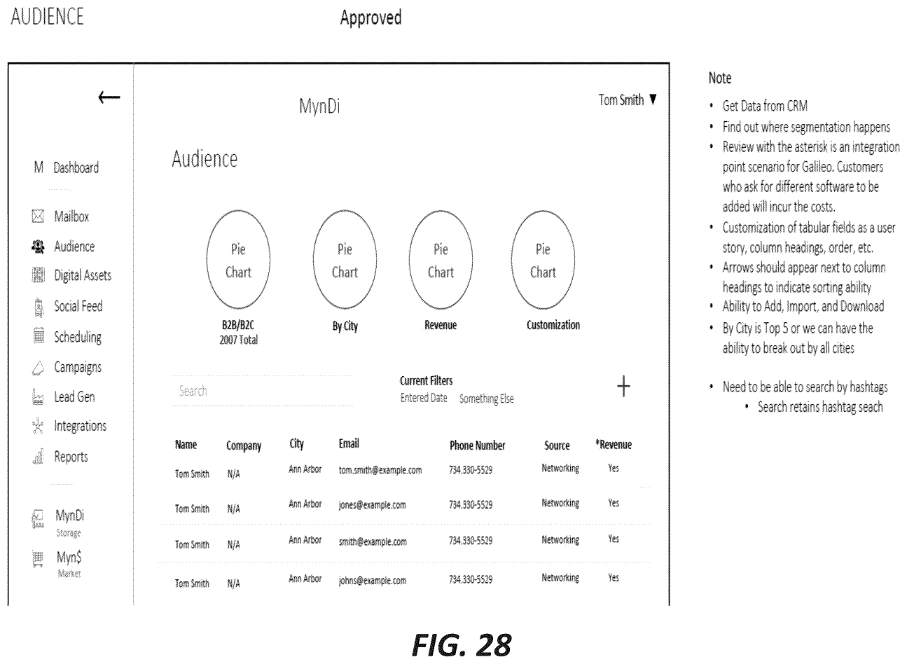

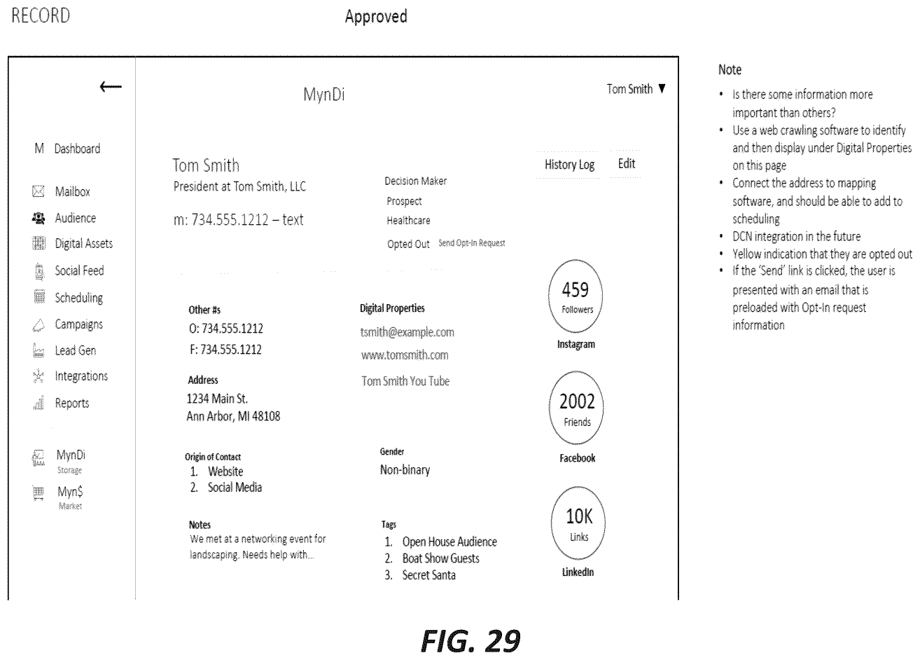

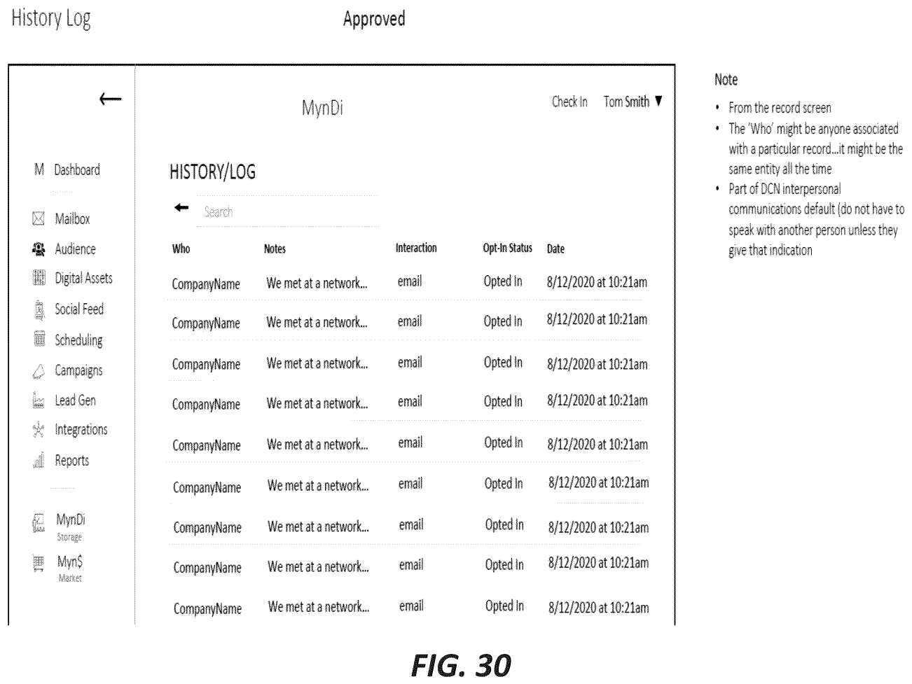

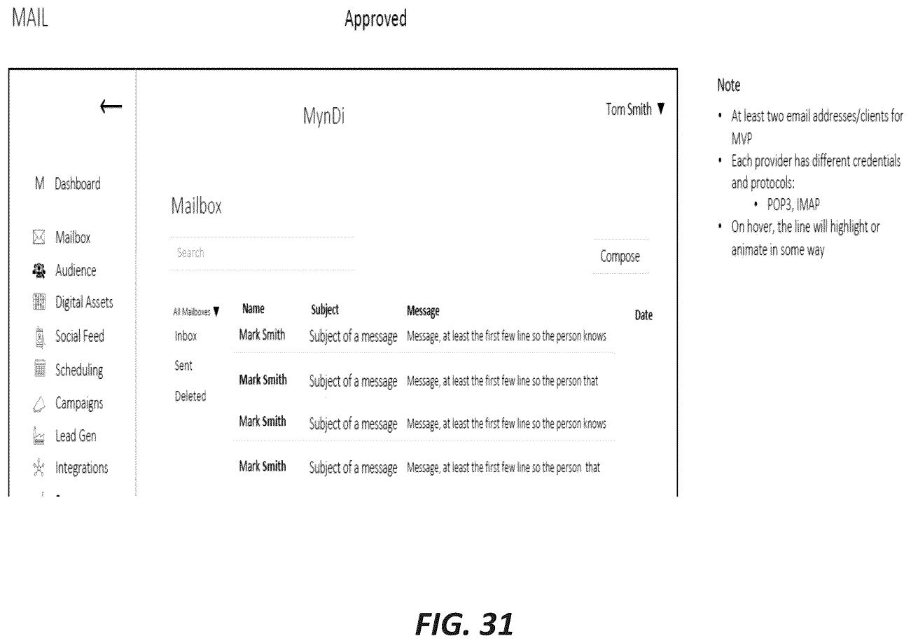

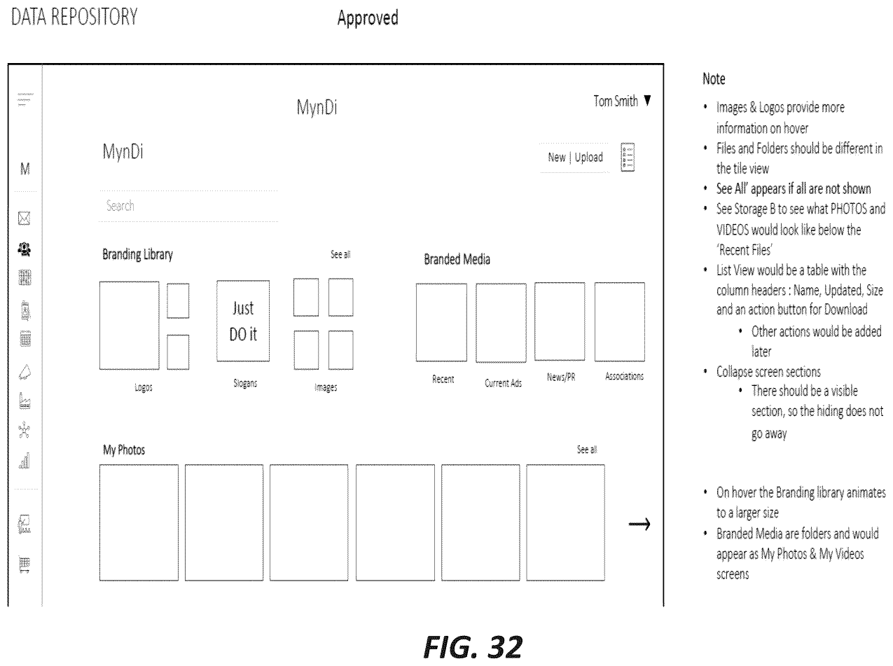

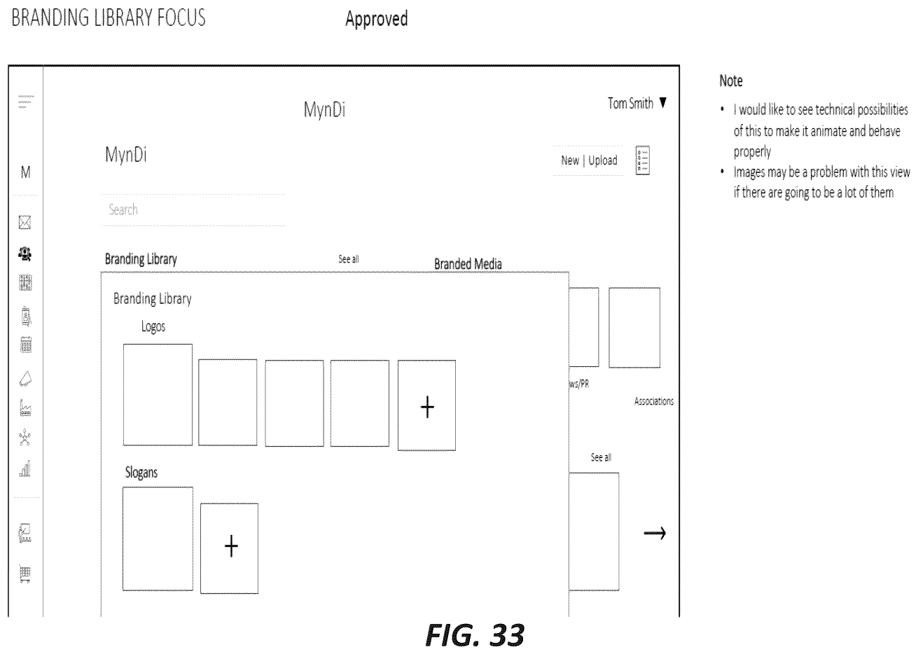

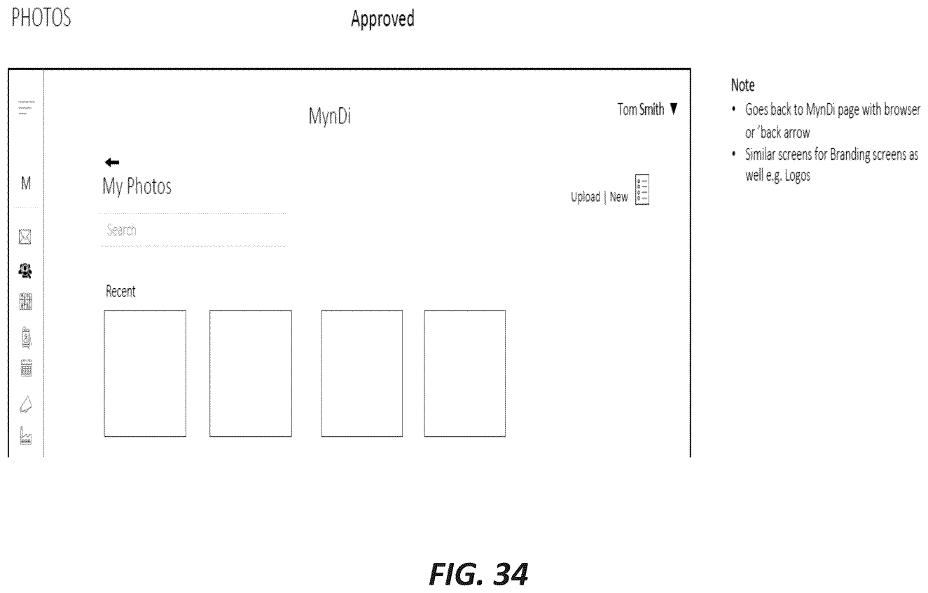

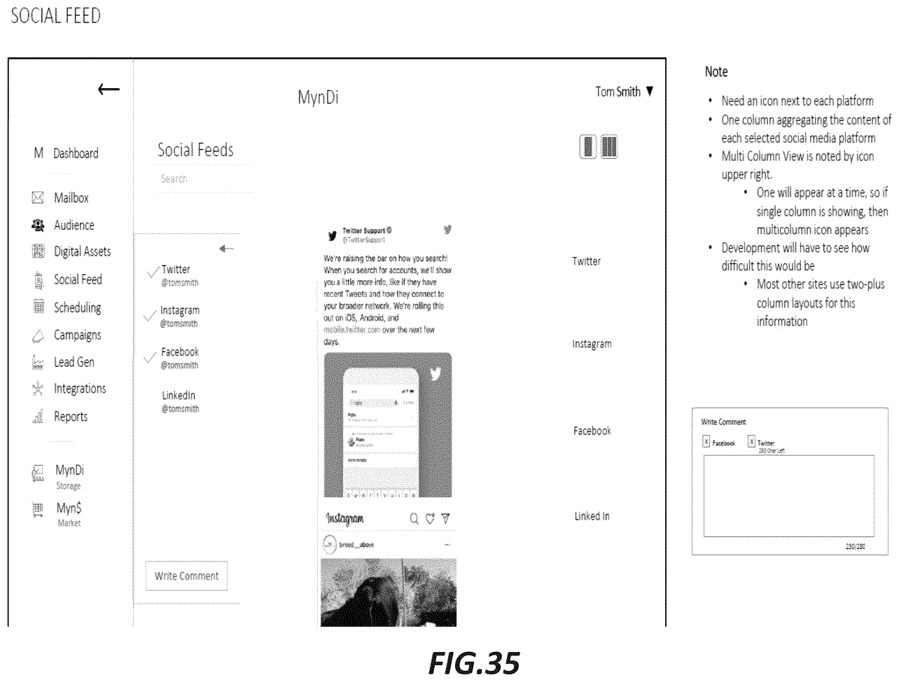

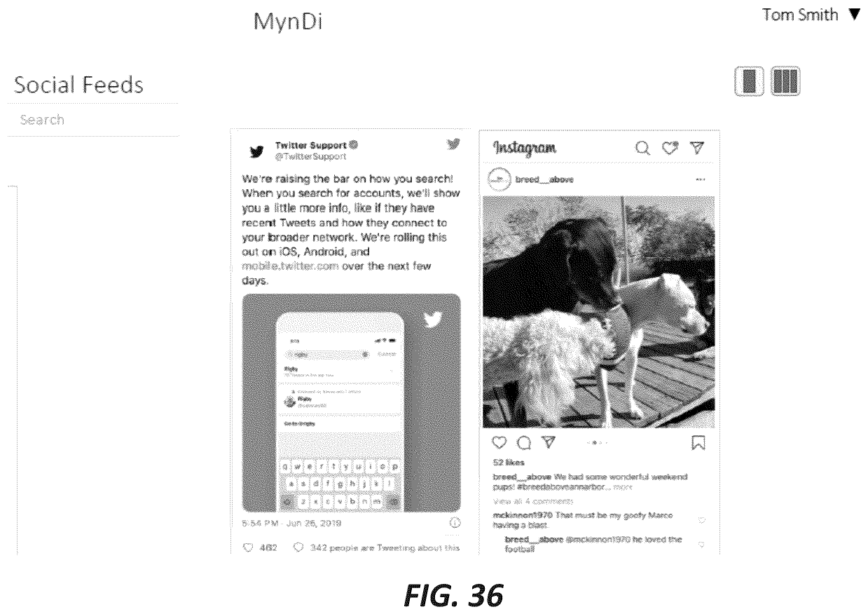

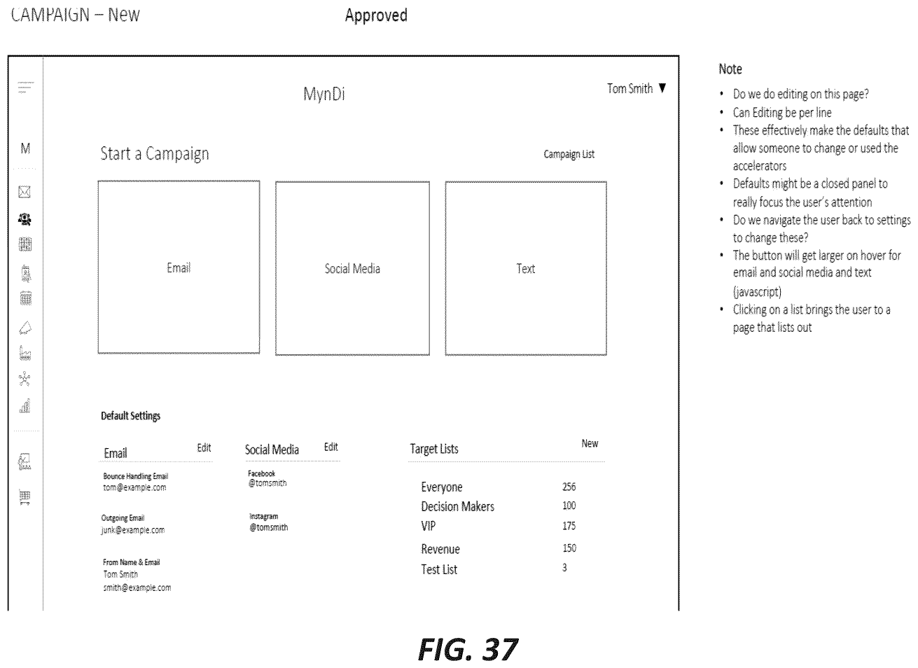

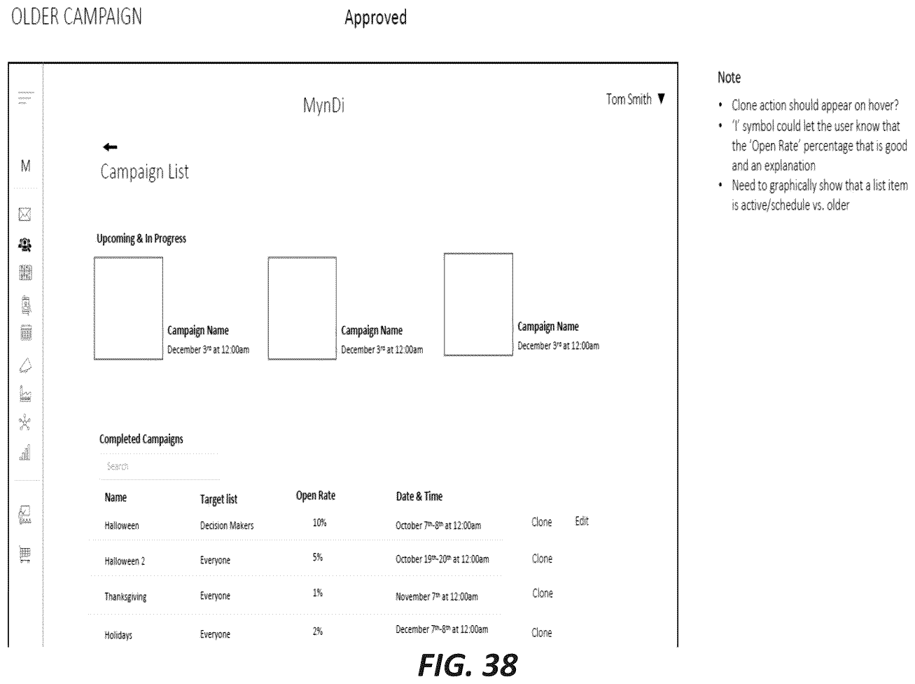

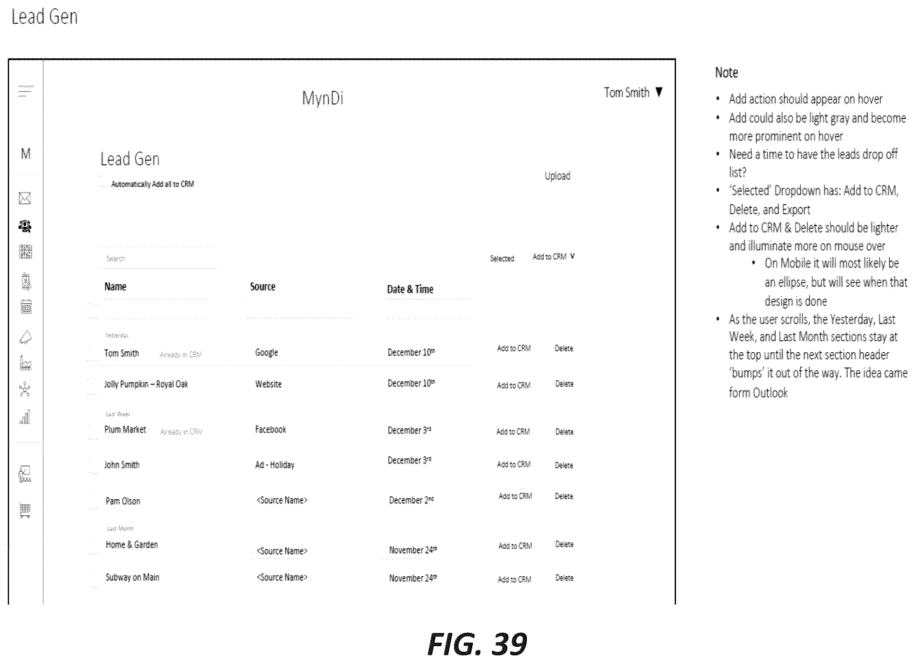

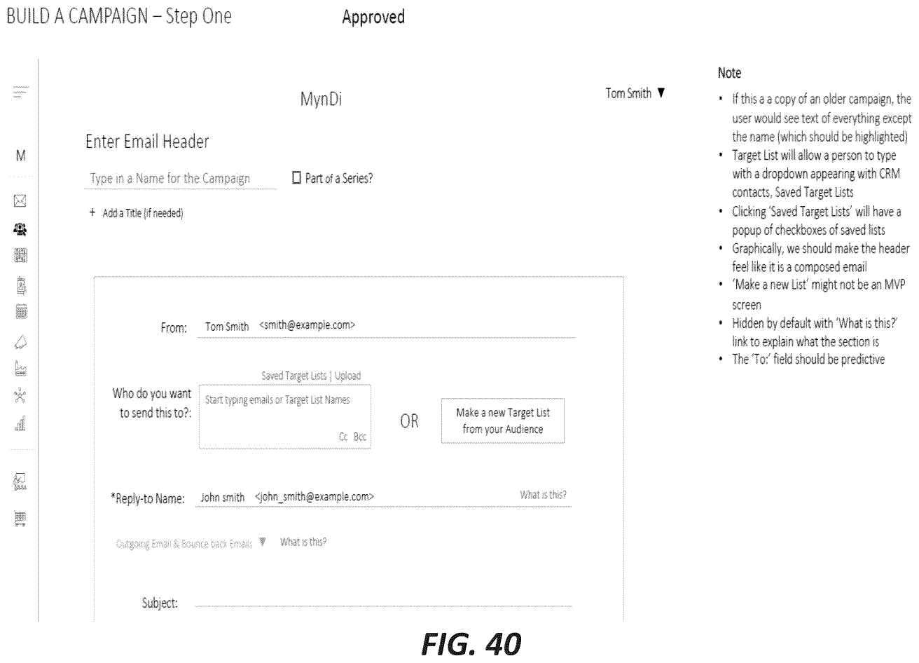

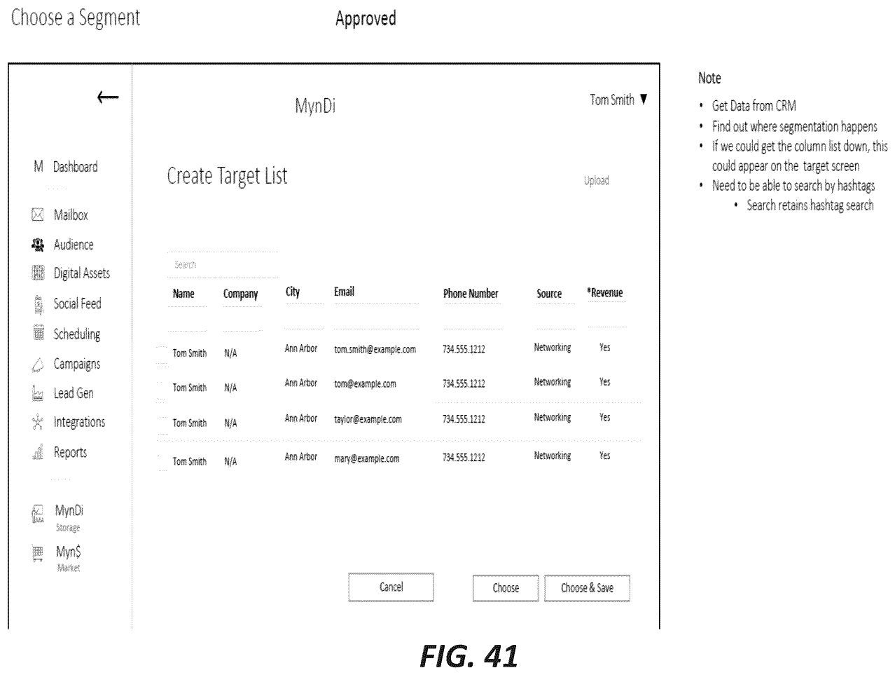

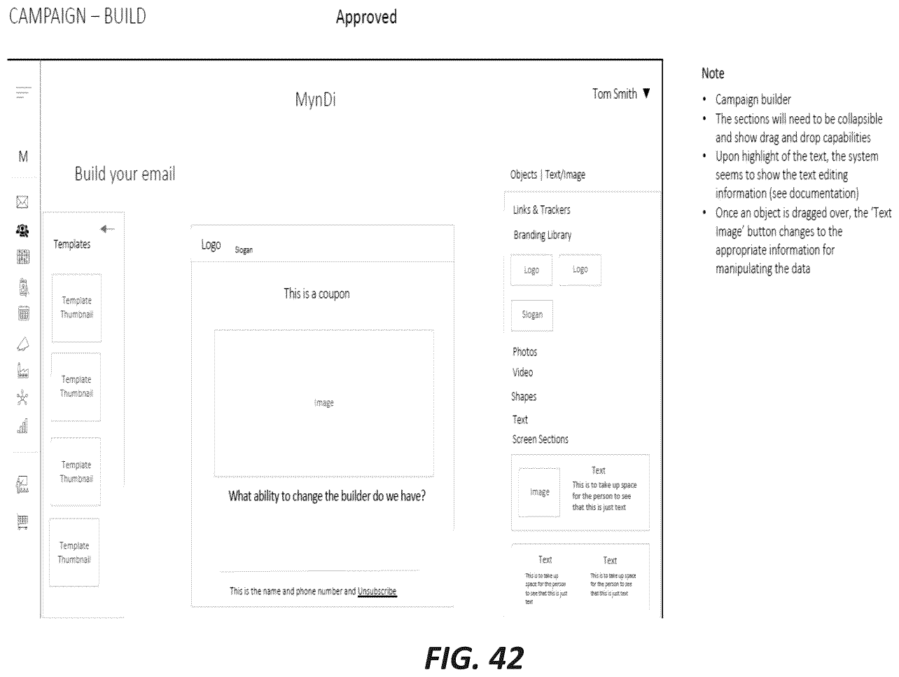

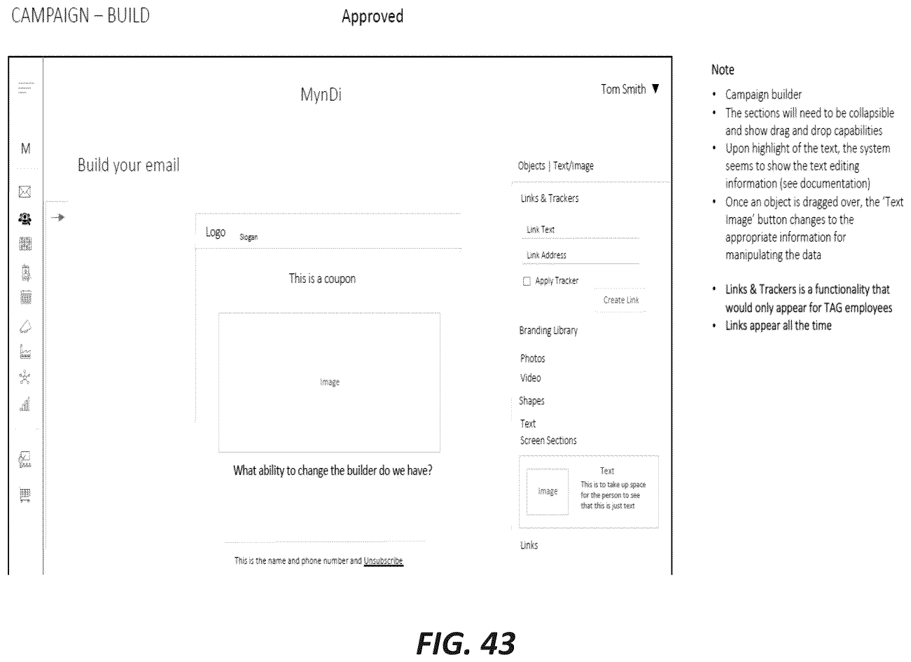

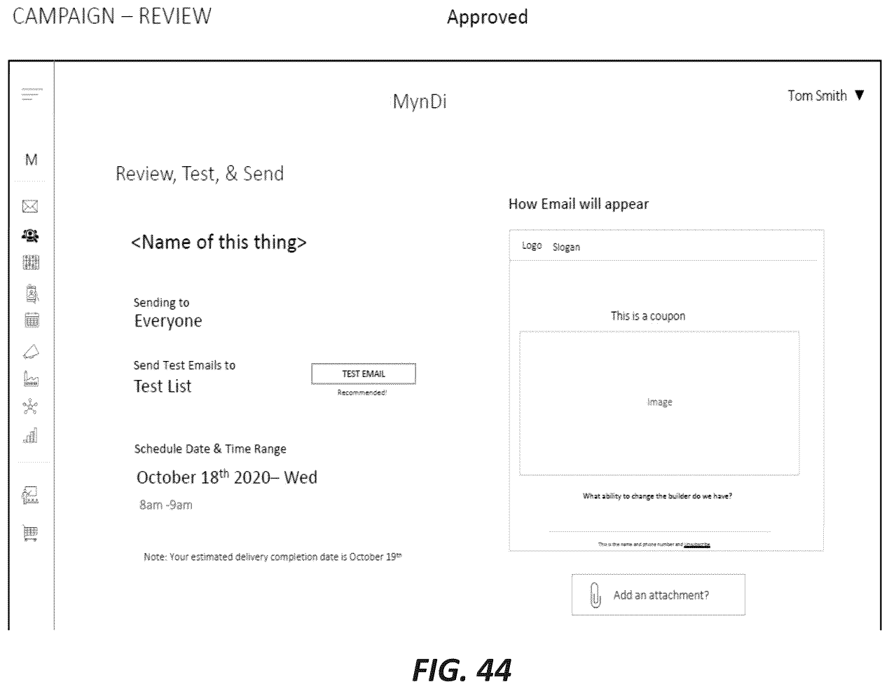

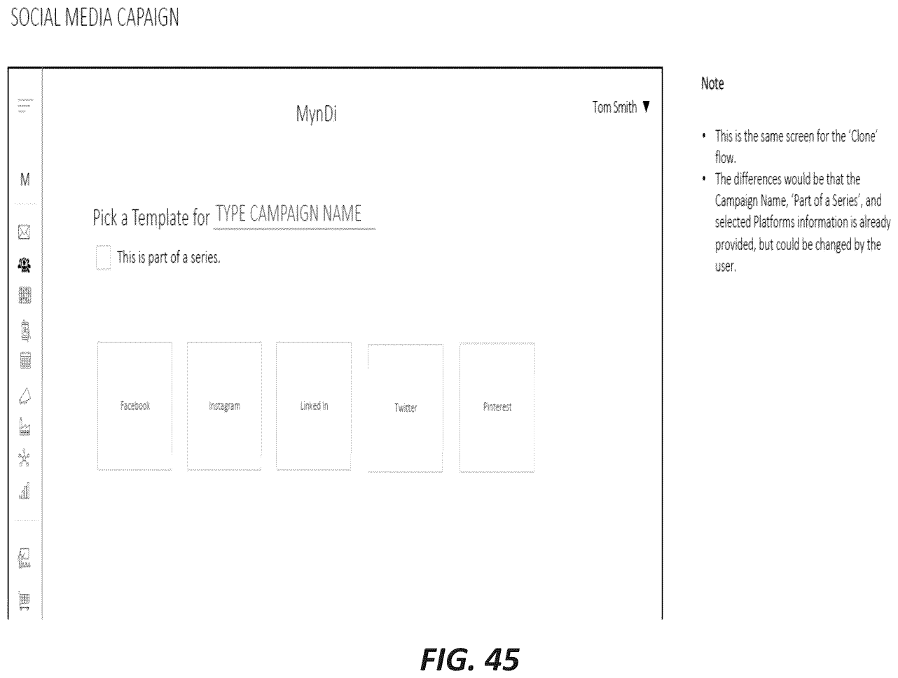

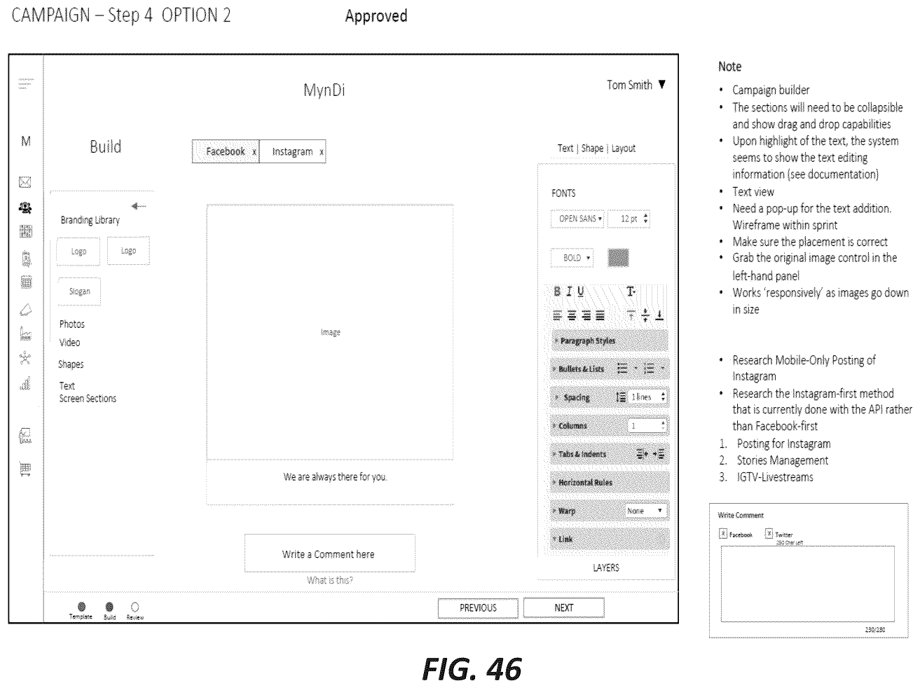

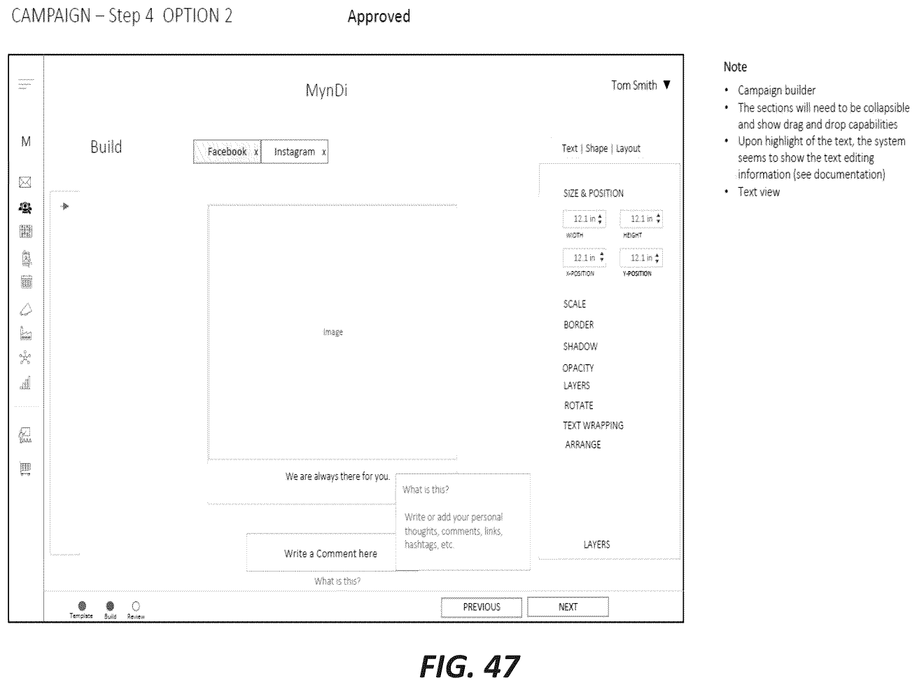

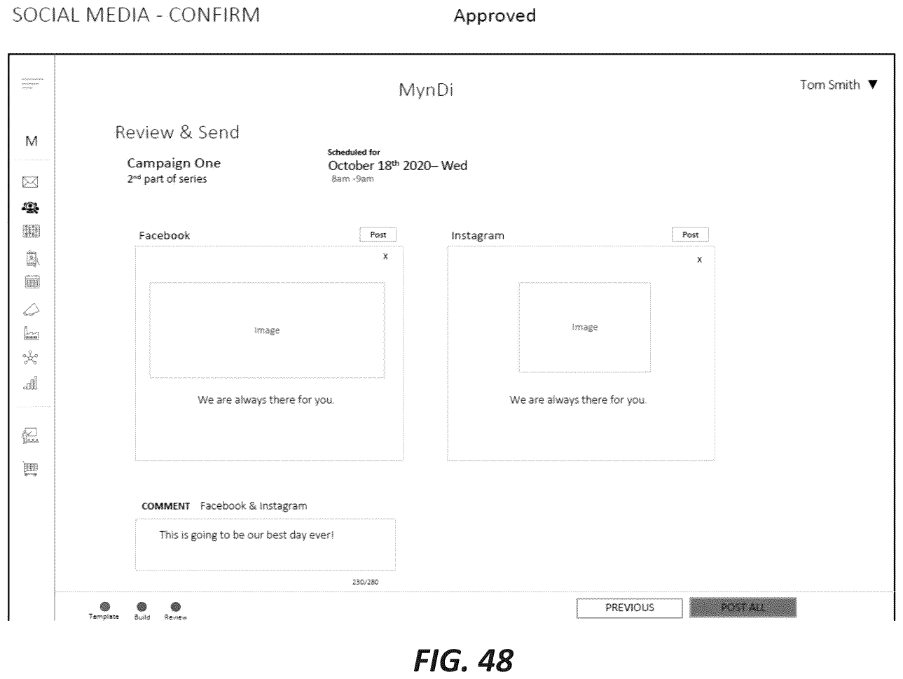

FIGS. 20-48 present user interfaces of various tools of the virtual marketplace platform. For example, the user interfaces may relate to CRM tool, a social media platform tool, a lead generation tool, an email tool, and the like. The various user interfaces may be presented to users associated with entities that register, sign up, subscribe or request to use the virtual marketplace platform.

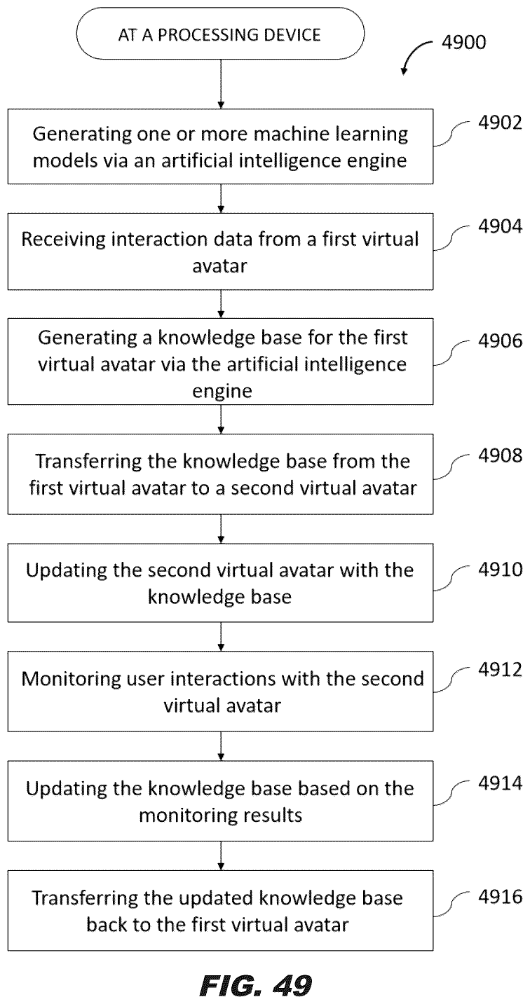

FIG. 49 illustrates example operations of a method 4900 a method 4900 for sharing knowledge between avatars in a virtual marketplace platform according to certain embodiments of this disclosure. The method 4900 may be performed by processing logic that may include hardware (circuitry, dedicated logic, etc.), software, or a combination of both. The method 300 and/or each of their individual functions, subroutines, or operations may be performed by one or more processors of a computing device (e.g., any component (server 128, etc.) of cloud-based computing system 116, or the computing device 102, of FIG. 1) implementing the method 300. The method 300 may be implemented as computer instructions stored on a memory device and executable by the one or more processors. In certain implementations, the method 300 may be performed by a single processing thread. Alternatively, the method 300 may be performed by two or more processing threads, each thread implementing one or more individual functions, routines, subroutines, or operations of the methods.

At block 4902, the method, operating in certain embodiments through a processing device, may begin with generating one or more machine learning models via an artificial intelligence engine. These models can be trained to receive input from a customer virtual avatar, where the input comprises questions posed by users within a virtual marketplace environment. The machine learning models can process these inputs to determine the appropriate output, which is an answer tailored to the user's inquiry.

At block 4904, the method may proceed, in some embodiments through the processing device, to receive interaction data from a first virtual avatar. This interaction data can include the outputs, i.e., answers generated by the machine learning models in response to user inquiries within the first virtual marketplace environment. Additionally, performance metrics associated with these outputs are collected, such as user satisfaction scores, engagement levels, and response times, to assess the effectiveness of the avatar's interactions.

At block 4906, the method may continue, in some embodiments through the processing device, to generate a knowledge base for the first virtual avatar via the artificial intelligence engine. This knowledge base can be operatively configured to store the interaction data along with corresponding performance metrics. The knowledge base serves as a repository of learned experiences and responses, enhancing the virtual avatar's ability to provide informed and contextually relevant interactions with users.

At block 4908, the method may continue, in some embodiments through the processing device, with the knowledge base from the first virtual avatar being transferred to a second virtual avatar, which operates in a different virtual marketplace environment. This step facilitates the sharing of accumulated knowledge and expertise, allowing the second avatar to benefit from the experiences and learning of the first avatar.

In some embodiments, the different virtual marketplace environment may be within the same platform. In other embodiments, the different virtual marketplace may be within an external platform. For example, in some embodiments, the virtual marketplace hosting the second virtual avatar may be a separate web host, game, or server that the virtual marketplace hosting the first virtual avatar. In some embodiments, the first virtual avatar and second virtual avatar may be in separate platforms commonly owned by the same entity. In other embodiments, the first virtual avatar and second virtual avatar may be hosted on separate platforms owned by separate entities. Further, in some embodiments, the first virtual avatar may be situated in a separate location in the same platform as the second virtual avatar.

At block 4910, the method may continue, in some embodiments through the processing device, with the second virtual avatar updating the transferred knowledge base. This update enables the second avatar to provide one or more targeted responses to user inquiries based on the enriched knowledge base. The second avatar can now deliver personalized and informed interactions tailored to the specific needs of users in its virtual marketplace environment.

In some embodiments, as shown at block 4912, the method can further include monitoring user interactions with the second virtual avatar. This monitoring process can involve tracking user engagement, satisfaction, and feedback to assess the effectiveness of the avatar's responses and the relevance of the knowledge base in the new environment.

In some embodiments, as shown at block 4914, the knowledge base can be further updated based on the monitoring results. In such an embodiment, the updating can involve refining and enhancing the knowledge base using the data gathered from user interactions with the second virtual avatar. The update ensures that the avatar continues to improve and adapt to user needs, providing increasingly relevant and accurate responses.

In some embodiments, as shown at block 4916, the updated knowledge base can be transferred back to the first virtual avatar. In such an embodiment, the bidirectional sharing can allow for continuous improvement and learning across different virtual environments, ensuring that both avatars benefit from shared experiences and insights, thereby enhancing their overall effectiveness.

In some embodiments, the method further comprises aggregating interaction data from multiple avatars operating in various virtual marketplace environments. In such an embodiment, the aggregation can enable a comprehensive and diverse knowledge base that enriches each avatar's capabilities, allowing them to provide enhanced and contextually aware interactions across different virtual settings.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

In embodiments of the present disclosure, the machine learning techniques utilized may include, but are not limited to, one or more of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or combinations thereof.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that although the previous paragraphs relate to embodiments where steps may be described as occurring in a certain order, no ordering is required unless otherwise stated. In fact, steps described in the previous paragraphs may occur in any order. Furthermore, although one step may be described in one figure and another step may be described in another figure, embodiments of the present disclosure are not limited to such combinations, as any of the steps described above may be combined in particular embodiments.

Those skilled in the art will further appreciate that although the examples described above relate to embodiments where an artificial intelligence infrastructure supports the execution of machine learning models, the artificial intelligence infrastructure may support the execution of a broader class of Artificial Intelligence algorithms, including production algorithms. In fact, the steps described above may similarly apply to such a broader class of AI algorithms.

Those skilled in the art will further appreciate that although the embodiments described above relate to embodiments where the artificial intelligence infrastructure includes one or more storage systems and one or more GPU servers, in other embodiments, other technologies may be used. For example, in some embodiments the GPU servers may be replaced by a collection of GPUs that are embodied in a non-server form factor. Likewise, in some embodiments, the GPU servers may be replaced by some other form of computer hardware that can execute computer program instructions, where the computer hardware that can execute computer program instructions may be embodied in a server form factor or in a non-server form factor.

Example embodiments are described largely in the context of a fully functional computer system. Those having skill in the art will recognize, nonetheless, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

Embodiments can include be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electro-magnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electro-magnetic waves, electro-magnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus, systems, systems-of-systems, and computer program products according to some embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

### CLAUSES

Clause 1. A method for executing a virtual marketplace platform comprising:
receiving one or more images of a physical location, wherein the one or more images comprise representations of one or more buildings associated with one or more entities present in the physical location;
generating a virtual cityscape by modeling the one or more buildings associated with the one or more entities, wherein the virtual cityscape comprises a virtual map configured to be navigated by one or more virtual avatars, virtual vehicles, or both;
generating the one or more virtual avatars and including the one or more virtual avatars in the virtual cityscape, wherein:
at least one of the virtual avatars comprises an entity virtual avatar associated with an entity occupying a virtual building in the virtual cityscape, and the entity virtual avatar is included inside the virtual building associated with the entity, and
at least one of the virtual avatars comprises a customer virtual avatar associated with a customer, and the customer virtual avatar is enabled to traverse the virtual cityscape by moving throughout one or more virtual streets, entering and exiting virtual buildings associated with entities, or some combination thereof;
receiving one or more images of an interior configuration of a real building associated with the virtual building; and
generating a virtual interior configuration that is similar to the interior configuration depicted in the one or more images and using the virtual interior configuration to populate an interior of the virtual building with one or more goods, products, furniture, objects, decorations, flooring, walls, ceilings, doors, windows, or some combination thereof.

Clause 2. The method of any clause herein, further comprising generating, via an artificial intelligence engine, one or more machine learning models trained to receive input from the customer virtual avatar and determine an output to respond to the input, wherein the input comprises a question and the output comprises an answer.

Clause 3. The method of any clause herein, wherein the question is associated with a product or service offered by the entity and the answer is associated with the product or the service.

Clause 4. The method of any clause herein, further comprising enabling two or more customer virtual avatars to communicate with each other after each of the users associated with the two or more customer virtual avatars provides consent.

Clause 5. The method of any clause herein, further comprising presenting the answer on a user interface of a computing device of the customer, and receiving a selection to add the product or the service to a virtual shopping cart provided by the virtual marketplace platform.

Clause 6. The method of any clause herein, further comprising providing a backend tool for the entity to enable the entity to create social media posts that are configured to be shared to a plurality of social media platforms simultaneously.

Clause 7. A tangible, non-transitory computer-readable medium storing instructions that, when executed, cause a processing device to:
receive one or more images of a physical location, wherein the one or more images comprise representations of one or more buildings associated with one or more entities present in the physical location;
generate a virtual cityscape by modeling the one or more buildings associated with the one or more entities, wherein the virtual cityscape comprises a virtual map configured to be navigated by one or more virtual avatars, virtual vehicles, or both;
generate the one or more virtual avatars and including the one or more virtual avatars in the virtual cityscape, wherein:
at least one of the virtual avatars comprises an entity virtual avatar associated with an entity occupying a virtual building in the virtual cityscape, and the entity virtual avatar is included inside the virtual building associated with the entity, and
at least one of the virtual avatars comprises a customer virtual avatar associated with a customer, and the customer virtual avatar is enabled to traverse the virtual cityscape by moving throughout one or more virtual streets, entering and exiting virtual buildings associated with entities, or some combination thereof;
receive one or more images of an interior configuration of a real building associated with the virtual building; and
generate a virtual interior configuration that is similar to the interior configuration depicted in the one or more images and using the virtual interior configuration to populate an interior of the virtual building with one or more goods, products, furniture, objects, decorations, flooring, walls, ceilings, doors, windows, or some combination thereof.

Clause 8. The computer-readable medium of any clause herein, wherein the processing device generates, via an artificial intelligence engine, one or more machine learning models trained to receive input from a customer virtual avatar and determine an output to respond to the input, wherein the input comprises a question and the output comprises an answer.

Clause 10. The computer-readable medium of any clause herein, wherein the question is associated with a product or service offered by the entity and the answer is associated with the product or the service.

Clause 11. The computer-readable medium of any clause herein, wherein the processing device generates two or more customer virtual avatars to communicate with each other after each of the users associated with the two or more customer virtual avatars provides consent.

Clause 12. The computer-readable medium of any clause herein, further comprising presenting the answer on a user interface of a computing device of the customer, and receiving a selection to add the product or the service to a virtual shopping cart provided by the virtual marketplace platform.

Clause 13. The computer-readable medium of any clause herein, wherein the processing device provides a backend tool for the entity to enable the entity to create social media posts that are configured to be shared to a plurality of social media platforms simultaneously.

Clause 14. A system comprising:
a memory device storing instructions;
a processing device communicatively coupled to the memory device, wherein the processing device executes the instructions to:
receive one or more images of a physical location, wherein the one or more images comprise representations of one or more buildings associated with one or more entities present in the physical location;
generate a virtual cityscape by modeling the one or more buildings associated with the one or more entities, wherein the virtual cityscape comprises a virtual map configured to be navigated by one or more virtual avatars, virtual vehicles, or both;
generate the one or more virtual avatars and including the one or more virtual avatars in the virtual cityscape, wherein:
at least one of the virtual avatars comprises an entity virtual avatar associated with an entity occupying a virtual building in the virtual cityscape, and the entity virtual avatar is included inside the virtual building associated with the entity, and
at least one of the virtual avatars comprises a customer virtual avatar associated with a customer, and the customer virtual avatar is enabled to traverse the virtual cityscape by moving throughout one or more virtual streets, entering and exiting virtual buildings associated with entities, or some combination thereof;
receive one or more images of an interior configuration of a real building associated with the virtual building; and
generate a virtual interior configuration that is similar to the interior configuration depicted in the one or more images and using the virtual interior configuration to populate an interior of the virtual building with one or more goods, products, furniture, objects, decorations, flooring, walls, ceilings, doors, windows, or some combination thereof.

Clause 15. The system of any clause herein, wherein the processing device generates, via an artificial intelligence engine, one or more machine learning models trained to receive input from a customer virtual avatar and determine an output to respond to the input, wherein the input comprises a question and the output comprises an answer.

Clause 16. The system of any clause herein, wherein the question is associated with a product or service offered by the entity and the answer is associated with the product or the service.

Clause 17. The system of any clause herein, wherein the processing device generates two or more customer virtual avatars to communicate with each other after each of the users associated with the two or more customer virtual avatars provides consent.

Clause 18. The system of any clause herein, further comprising presenting the answer on a user interface of a computing device of the customer, and receiving a selection to add the product or the service to a virtual shopping cart provided by the virtual marketplace platform.

Clause 19. The system of any clause herein, wherein the processing device provides a backend tool for the entity to enable the entity to create social media posts that are configured to be shared to a plurality of social media platforms simultaneously.

Clause 20. The system of any clause herein, wherein the processing device transmit information pertaining to interactions associated with the customer virtual avatar to a customer relationship management platform via an application programming interface.

Clause 21. A method for sharing knowledge between avatars in a virtual marketplace platform, comprising:
generating, via an artificial intelligence engine, one or more machine learning models trained to receive input from a customer virtual avatar, determine an output to respond to the input, wherein the input comprises a question and the output comprises an answer;
receiving interaction data from a first virtual avatar, the interaction data comprising the output within a first virtual marketplace environment and performance metrics associated with the output;
generating, via the artificial intelligence engine, a knowledge base for the first virtual avatar using the interaction data, wherein the knowledge base is operatively configured to store the interaction data corresponding to the performance metrics;
transferring the knowledge base from the first virtual avatar to a second virtual avatar, wherein the second virtual avatar operates in a second virtual marketplace environment; and
updating the second virtual avatar with the knowledge base, enabling the second virtual avatar to provide one or more targeted responses to user inquiries based on the knowledge base.

Clause 22. The method of any clause herein, further comprising monitoring user interactions with the second virtual avatar

Clause 23. The method of any clause herein, further comprising updating the knowledge base based on monitoring user interactions with the second virtual avatar, wherein the updating of the knowledge base results in an updated knowledge base.

Clause 24. The method of any clause herein, further comprising transferring the updated knowledge base back to the first virtual avatar.

Clause 25. The method of any clause herein, wherein at least one of the first virtual avatar or the second virtual avatar comprises an entity virtual avatar associated with an entity occupying a virtual building in the virtual cityscape, and the entity virtual avatar is included inside the virtual building associated with the entity.

Clause 26. The method of any clause herein, wherein the knowledge base comprises interaction data from one or more additional virtual avatars operating in one or more additional virtual marketplace environments.

Clause 27. A tangible, non-transitory computer-readable medium storing instructions that, when executed, cause a processing device to:
generate, via an artificial intelligence engine, one or more machine learning models trained to receive input from a customer virtual avatar, determine an output to respond to the input, wherein the input comprises a question and the output comprises an answer;
receive interaction data from a first virtual avatar, the interaction data comprising the output within a first virtual marketplace environment and performance metrics associated with the output;
generate, via the artificial intelligence engine, a knowledge base for the first virtual avatar using the interaction data, wherein the knowledge base is operatively configured to store the interaction data corresponding to the performance metrics;
transfer the knowledge base from the first virtual avatar to a second virtual avatar, wherein the second virtual avatar operates in a second virtual marketplace environment; and
update the second virtual avatar with the knowledge base, enabling the second virtual avatar to provide one or more targeted responses to user inquiries based on the knowledge base.

Clause 28. The computer-readable medium of any clause herein, wherein the computer-readable medium is further configured to monitor user interactions with the second virtual avatar.

Clause 29. The computer-readable medium of any clause herein, wherein the computer-readable medium is further configured to update the knowledge base based on monitoring user interactions with the second virtual avatar, wherein the update of the knowledge base results in an updated knowledge base.

Clause 30. The computer-readable medium of any clause herein, wherein the computer-readable medium is further configured to transfer the updated knowledge base back to the first virtual avatar.

Clause 31. The computer-readable medium of any clause herein, wherein at least one of the first virtual avatar or the second virtual avatar comprises an entity virtual avatar associated with an entity occupying a virtual building in the virtual cityscape, and the entity virtual avatar is included inside the virtual building associated with the entity.

Clause 32. The computer-readable medium of any clause herein, wherein the knowledge base comprises interaction data from one or more additional virtual avatars operating in one or more additional virtual marketplace environments.

Clause 33. The computer-readable medium of any clause herein claim 12, wherein one or more additional virtual avatars are accessible via an application programming interface associated with another system and one or more additional virtual avatars are implemented in the another system.

Clause 34. A system comprising:
a memory device storing instructions;
a processing device communicatively coupled to the memory device, wherein the processing device executes the instructions to:
generate, via an artificial intelligence engine, one or more machine learning models trained to receive input from a customer virtual avatar, determine an output to respond to the input, wherein the input comprises a question and the output comprises an answer;
receive interaction data from a first virtual avatar, the interaction data comprising the output within a first virtual marketplace environment and performance metrics associated with the output;
generate, via the artificial intelligence engine, a knowledge base for the first virtual avatar using the interaction data, wherein the knowledge base is operatively configured to store the interaction data corresponding to the performance metrics;
transfer the knowledge base from the first virtual avatar to a second virtual avatar, wherein the second virtual avatar operates in a second virtual marketplace environment; and
update the second virtual avatar with the knowledge base, enabling the second virtual avatar to provide one or more targeted responses to user inquiries based on the knowledge base.

Clause 35. The system of any clause herein, wherein the processing device is further configured to monitor user interactions with the second virtual avatar.

Clause 36. The system of any clause herein, wherein the processing device is further configured to update the knowledge base based on monitoring user interactions with the second virtual avatar, wherein the update of the knowledge base results in an updated knowledge base.

Clause 37. The system of any clause herein, wherein the processing device is further configured to transfer the updated knowledge base back to the first virtual avatar.

Clause 38. The system of any clause herein, wherein at least one of the first virtual avatar or the second virtual avatar comprises an entity virtual avatar associated with an entity occupying a virtual building in the virtual cityscape, and the entity virtual avatar is included inside the virtual building associated with the entity.

Clause 39. The system of any clause herein, wherein the knowledge base comprises interaction data from one or more additional virtual avatars operating in one or more additional virtual marketplace environments.

Clause 40. The system of any clause herein, wherein one or more additional virtual avatars are accessible via an application programming interface associated with another system and one or more additional virtual avatars are implemented in the another system.

Clause 41. The method, computer-readable medium, or system of any clause herein, wherein the knowledge base of the first virtual comprises a large language model trained on the interaction data from the first virtual avatar.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

1. A method for sharing knowledge between avatars in a virtual marketplace platform, comprising:
generating, via an artificial intelligence engine, one or more machine learning models trained to receive input from a customer virtual avatar and determine an output to respond to the input, wherein the input comprises a question and the output comprises an answer;
receiving interaction data from a first virtual avatar, the interaction data comprising the output within a first virtual marketplace environment and performance metrics associated with the output;
generating, via the artificial intelligence engine, a knowledge base for the first virtual avatar using the interaction data, wherein the knowledge base is operatively configured to store the interaction data corresponding to the performance metrics;
transferring the knowledge base from the first virtual avatar to a second virtual avatar, wherein the second virtual avatar operates in a second virtual marketplace environment; and
updating the second virtual avatar with the knowledge base, enabling the second virtual avatar to provide one or more targeted responses to user inquiries based on the knowledge base.

2. The method of claim 1, wherein the knowledge base of the first virtual comprises a large language model trained on the interaction data from the first virtual avatar.

3. The method of claim 1, further comprising updating the knowledge base based on monitoring user interactions with the second virtual avatar, wherein the updating of the knowledge base results in an updated knowledge base.

4. The method of claim 3, further comprising transferring the updated knowledge base back to the first virtual avatar.

5. The method of claim 1, wherein at least one of the first virtual avatar or the second virtual avatar comprises an entity virtual avatar associated with an entity occupying a virtual building in the virtual cityscape, and the entity virtual avatar is included inside the virtual building associated with the entity.

6. The method of claim 1, wherein the knowledge base comprises interaction data from one or more additional virtual avatars operating in one or more additional virtual marketplace environments.

7. A tangible, non-transitory computer-readable medium storing instructions that, when executed, cause a processing device to:
generate, via an artificial intelligence engine, one or more machine learning models trained to receive input from a customer virtual avatar, determine an output to respond to the input, wherein the input comprises a question and the output comprises an answer;
receive interaction data from a first virtual avatar, the interaction data comprising the output within a first virtual marketplace environment and performance metrics associated with the output;
generate, via the artificial intelligence engine, a knowledge base for the first virtual avatar using the interaction data, wherein the knowledge base is operatively configured to store the interaction data corresponding to the performance metrics;
transfer the knowledge base from the first virtual avatar to a second virtual avatar, wherein the second virtual avatar operates in a second virtual marketplace environment; and
update the second virtual avatar with the knowledge base, enabling the second virtual avatar to provide one or more targeted responses to user inquiries based on the knowledge base.

8. The computer-readable medium of claim 7, wherein the knowledge base of the first virtual comprises a large language model trained on the interaction data from the first virtual avatar.

9. The computer-readable medium of claim 7, wherein the computer-readable medium is further configured to update the knowledge base based on monitoring user interactions with the second virtual avatar, wherein the update of the knowledge base results in an updated knowledge base.

10. The computer-readable medium of claim 7, wherein the computer-readable medium is further configured to transfer the updated knowledge base back to the first virtual avatar.

11. The computer-readable medium of claim 7, wherein at least one of the first virtual avatar or the second virtual avatar comprises an entity virtual avatar associated with an entity occupying a virtual building in the virtual cityscape, and the entity virtual avatar is included inside the virtual building associated with the entity.

12. The computer-readable medium of claim 7, wherein the knowledge base comprises interaction data from one or more additional virtual avatars operating in one or more additional virtual marketplace environments.

13. The computer-readable medium of claim 12, wherein one or more additional virtual avatars are accessible via an application programming interface associated with another system and one or more additional virtual avatars are implemented in the another system.

14. A system comprising:
a memory device storing instructions;
a processing device communicatively coupled to the memory device, wherein the processing device executes the instructions to:
generate, via an artificial intelligence engine, one or more machine learning models trained to receive input from a customer virtual avatar, determine an output to respond to the input, wherein the input comprises a question and the output comprises an answer;
receive interaction data from a first virtual avatar, the interaction data comprising the output within a first virtual marketplace environment and performance metrics associated with the output;
generate, via the artificial intelligence engine, a knowledge base for the first virtual avatar using the interaction data, wherein the knowledge base is operatively configured to store the interaction data corresponding to the performance metrics;
transfer the knowledge base from the first virtual avatar to a second virtual avatar, wherein the second virtual avatar operates in a second virtual marketplace environment; and
update the second virtual avatar with the knowledge base, enabling the second virtual avatar to provide one or more targeted responses to user inquiries based on the knowledge base.

15. The system of claim 14, wherein the knowledge base of the first virtual comprises a large language model trained on the interaction data from the first virtual avatar.

16. The system of claim 14, wherein the processing device is further configured to update the knowledge base based on monitoring user interactions with the second virtual avatar, wherein the update of the knowledge base results in an updated knowledge base.

17. The system of claim 16, wherein the processing device is further configured to transfer the updated knowledge base back to the first virtual avatar.

18. The system of claim 14, wherein at least one of the first virtual avatar or the second virtual avatar comprises an entity virtual avatar associated with an entity occupying a virtual building in the virtual cityscape, and the entity virtual avatar is included inside the virtual building associated with the entity.

19. The system of claim 14, wherein the knowledge base comprises interaction data from one or more additional virtual avatars operating in one or more additional virtual marketplace environments.

20. The system of claim 12, wherein one or more additional virtual avatars are accessible via an application programming interface associated with another system and one or more additional virtual avatars are implemented in the another system.
